(19) United States
(12) Patent Application Publication
(10) Pub. No.: US 2026/0236308 A1
(43) Pub. Date: Aug. 13, 2026

(54) AGENTIC WORKFLOW WITH RESPONSE INSTRUCTIONS

(71) Applicant: SHOPIFY INC., Ottawa (CA)

(72) Inventors: Ben Lafferty, New York, NY (US); Charles Lee, South San Francisco, CA (US); Andrew McNamara, Belwood (CA); Ates Göral, Toronto (CA); Christopher Maltais, Vancouver (CA); Felipe Bezerra Leusin de Amorim, Oakville (CA)

(21) Appl. No.: 19/098,447

(22) Filed: Apr. 2, 2025

Related U.S. Application Data
(60) Provisional application No. 63/764,717, filed on Feb. 28, 2025.
(60) Provisional application No. 63/756,624, filed on Feb. 10, 2025.

(51) Int. Cl. G06F 9/50; G06F 11/07

(52) U.S. Cl. CPC G06F 9/5033; G06F 11/0721; G06F 11/0793

(57) ABSTRACT

Artificial intelligence (AI) agents may produce errors from responses to their requests which they are not properly configured to handle. To address at least this technical problem, in some examples, the first AI agent may transmit a request to a first resource. The first AI agent may receive a response bundle responsive to the request from the first AI agent. The response bundle may include a response from the first resource to the request and an instruction for the first AI agent. The first AI agent may perform an operation responsive to the instruction. In some examples, the instruction may instruct the first AI agent to handle the response from the first resource in a way specified by the instruction.

### RELATED APPLICATION

This application claims the benefit of and priority from United States provisional patent application no. US 63/756,624, filed Feb. 10, 2025, and United States provisional patent application no. US 63/764,717, filed Feb. 28, 2025. The entire contents of each of these U.S. provisional patent applications are incorporated herein by reference.

### FIELD

The present application relates to artificial intelligence (AI) agents, and more particularly to providing instructions to AI agents.

### BACKGROUND

Artificial intelligence (AI) architectures may now employ AI agents to accomplish complex tasks. As used herein, an AI agent is a software module capable of operating independently to accomplish a task. In many examples, the AI agent may include a large language model (LLM).

### SUMMARY

AI agents may operate within a workflow. As used herein, the term “workflow” may describe at least one AI agent interacting with at least one computing resource to perform one or more tasks. This resource may be another AI agent or another software tool that does not necessarily involve AI, such as a database or iterative code for querying a database, a website, an analytics tool or some other module which receives input and generates output.

A workflow may also describe several AI agents and/or resources interacting with each other serially or in parallel to accomplish one or more tasks. The term “serially” indicates that an AI agent or resource may operate at a higher level of the workflow hierarchy than another AI agent or resource, while the term “in parallel” indicates that the AI agent or resource operates at the same level of the workflow hierarchy as the other AI agent or resource. As well, the terms “system” and “architecture,” as used herein, may also be used to describe the AI agents and resources which operate within a workflow, in addition to the relationships between these AI agents and resources.

In operation, a first AI agent may receive a message from a computing device. The computing device may be a user device and the message may be from a user. Alternatively, the computing device may be a server or some other computing device hosting or storing another AI agent or some other software tool. For example, the message could include a request for the first AI agent to accomplish a specific task, such as to perform an operation. In response to receiving the message, the first AI agent may make its own request to a first resource with specialist knowledge to help generate a reply.

Accordingly, the first resource may generate a response to the request from the first AI agent. Although the first AI agent may receive the response from the first resource, the first AI agent may not be properly configured to handle the response. For example, the first AI agent may not be properly trained to interpret or format the response from the first resource. In other examples, the response from the first resource may be insufficient, and more information from the first AI agent to the first resource or from the first resource to the first AI agent may be required for the response to be handled effectively.

Since the first AI agent may not be properly configured to handle the response received from the first resource, the first AI agent may be more likely to produce errors while generating its reply to the original message based on the response received from the first resource. For example, if the first resource does not provide sufficient information in the response, the first AI agent may be likely to include errors in its reply to the message from the computing device. Errors may include errors due to a lack of information and may include hallucination.

Although it may be possible to prompt the first AI agent with instructions about how to handle a response received from the first resource, this approach may become intractable as the complexity of the architecture increases, such as where the first AI agent and the first resource are only one of many AI agents and resources in the system or workflow. For example, the first resource may also be an AI agent, e.g. a second AI agent, which may provide a request to a second resource. It may be difficult to propagate instructions for how the second AI agent is to handle the response from the second resource in the message from the computing device to the first AI agent. This would require the first AI agent to be provided with information about the second resource, which operates further down in the workflow hierarchy, complicating the system and consuming significant computational resources (e.g. memory) as the workflow grows more complex.

As well, solutions which involve training the first AI agent on the particular resource may also become intractable as complexity increases. As the number of AI agents and/or resources increases, so do the computing resources necessary to either train the AI agents based on the different resources or to set up workflows to address edge cases.

In addition to these challenges, the workflow also functions less effectively when the first AI agent is either unequipped to handle a response from the first resource or when messages/prompts to the first AI agent must be over-engineered to ensure responses from the first resource are handled properly by the first AI agent. As developers add further complexity to the system or workflow, significant testing must be performed to ensure that edge-cases and new workflows are considered. In addition to consuming significant computational resource just to test this system, the system may still not function as effectively as it should because entire workflows must be hardcoded into the top layers of the system (e.g. at the top-level message or prompt to the first AI agent or to whichever agent instructs the workflow). Nuances of resources within the workflow may be inadvertently omitted, and the system’s performance may ultimately suffer.

One solution to these problems is to configure the workflow to provide a computer-executable instruction back to the first AI agent in addition to the response from the first resource. The instruction may provide the first AI agent with more direction or information for how to interpret or handle the response from the first resource. It will be understood that rather than including this instruction with the original message from the computing device to the first AI agent, requiring the user, AI agent or tool instructing the first AI agent to have knowledge of the first resource, the first resource itself or another module may be tasked with managing this knowledge. As a result, the first AI agent and the first resource may be “decoupled” from one another. Similarly, the user, AI agent or tool instructing the first AI agent may also be decoupled from the first resource.

In one aspect, there is provided a computer-implemented method. The method may include transmitting, to a first resource, a request from a first artificial intelligence (AI) agent. The method may further include receiving, at the first AI agent, a response bundle responsive to the request from the first AI agent, the response bundle including a response from the first resource to the request and an instruction for the first AI agent. The method may further include performing, by the first AI agent, an operation responsive to the instruction.

In some implementations, the instruction may instruct the first AI agent to handle the response from the first resource in a way specified by the instruction.

In some implementations, the instruction may be at least one of an instruction for formatting the response, an instruction for error handling, an instruction to refer the request from the first AI agent to another resource, an instruction to provide more information to the first resource, an instruction for the first AI agent to obtain more information, an instruction for the first AI agent not to perform an operation, or task feedback for the first AI agent responsive to the request.

In some implementations, the method may further include receiving, at the first AI agent, a message from a computing device, wherein the first AI agent transmits the request to the first resource responsive to receiving the message; prompting the first AI agent with the response from the first resource and the instruction for the first AI agent to perform the operation; generating, responsive to the prompt, a reply from the first AI agent to the message, wherein the reply comprises content from the response handled in a way specified by the instruction; and transmitting, to the computing device, the reply from the first AI agent.

In some implementations, the response bundle may further include an example based on the instruction for the first AI agent.

In some implementations, the first resource is a second AI agent.

In some implementations, the method may further include transmitting, to a second resource, a request from the first resource, wherein the request from the first resource is based on the request from the first AI agent; receiving, at the first resource, a second response bundle responsive to the request from the first resource, the second response bundle comprising a response from the second resource to the request from the first resource and an instruction for the first resource; and generating at least one of the response from the first resource or the instruction for the first AI agent based on the second response bundle.

In some implementations, the method may further include validating the response bundle before the first AI agent receives the response bundle.

In some implementations, the method may further include determining the instruction for the first AI agent based on the response from the first resource.

In some implementations, performing, by the first AI agent, an operation responsive to the instruction may include: parsing, by the first AI agent, the instruction from the response bundle; and performing, based on the parsed instruction, the operation using content included in the response from the first resource.

In some implementations, the response from the first resource may be empty and the instruction may be for error handling.

In another aspect, there is provided a system. The system may include a memory. The system may further include a processor to: transmit, to a first resource, a request from a first artificial intelligence (AI) agent; receive, at the first AI agent, a response bundle responsive to the request from the first AI agent, the response bundle comprising a response from the first resource to the request and an instruction for the first AI agent; and perform, by the first AI agent, an operation responsive to the instruction.

In some implementations, the instruction may instruct the first AI agent to handle the response from the first resource in a way specified by the instruction.

In some implementations, the instruction may be at least one of an instruction for formatting the response, an instruction for error handling, an instruction to refer the request from the first AI agent to another resource, an instruction to provide more information to the first resource, an instruction for the first AI agent to obtain more information, an instruction for the first AI agent not to perform an operation, or task feedback for the first AI agent responsive to the request.

In some implementations, the at least one processor may be to: receive, at the first AI agent, a message from a computing device, wherein the first AI agent transmits the request to the first resource responsive to receiving the message; prompt the first AI agent with the response from the first resource and the instruction for the first AI agent to perform the operation; generate, responsive to the prompt, a reply from the first AI agent to the message, wherein the reply comprises content from the response handled in a way specified by the instruction; and perform, by the first AI agent, an operation responsive to the instruction.

In some implementations, the response bundle may further include an example based on the instruction for the first AI agent.

In some implementations, the first resource may be a second AI agent.

In some implementations, the at least one processor may be to: transmit, to a second resource, a request from the first resource, wherein the request from the first resource is based on the request from the first AI agent; receive, at the first resource, a second response bundle responsive to the request from the first resource, the second response bundle comprising a response from the second resource to the request from the first resource and an instruction for the first resource; and generate at least one of the response from the first resource or the instruction for the first AI agent based on the second response bundle.

In some implementations, the at least one processor may be to validate the response bundle before the first AI agent receives the response bundle.

In some implementations, the at least one processor may be to determine the instruction for the first AI agent based on the response from the first resource.

In some implementations, performing, by the first AI agent, an operation responsive to the instruction may include: parsing, by the first AI agent, the instruction from the response bundle; and performing, based on the parsed instruction, the operation using content included in the response from the first resource.

In some implementations, the response from the first resource may be empty and the instruction may be for error handling.

In another aspect, there is provided one or more computer readable media having stored thereon computer-executable instructions that, when executed by at least one computer, cause the at least one computer to perform a method including: transmitting, to a first resource, a request from a first artificial intelligence (AI) agent; receiving, at the first AI agent, a response bundle responsive to the request from the first AI agent, the response bundle comprising a response from the first resource to the request and an instruction for the first AI agent; and performing, by the first AI agent, an operation responsive to the instruction. The one or more computer readable media may be non-transitory.

### BRIEF DESCRIPTION OF THE DRAWINGS

Embodiments will be described, by way of example only, with reference to the accompanying figures wherein:

FIG. 1A is a simplified block diagram of an example simplified convolutional neural network;

FIG. 1B is a simplified block diagram of an example transformer neural network;

FIG. 2 is a block diagram of an example computing system;

FIGS. 3A-3C are block diagrams depicting example workflows with serial and parallel configurations;

FIG. 4 is a block diagram of an example system for executing a workflow, according to some implementations;

FIG. 5 is a block diagram of an example workflow;

FIG. 6 is a block diagram an example workflow with a response bundle, according to some implementations;

FIG. 7 is a block diagram of the response bundle of FIG. 6, according to some implementations;

FIG. 8 is a block diagram of an example instruction from the response bundle of FIG. 6;

FIG. 9 is a block diagram of the response bundle of FIG. 7, according to some other implementations;

FIG. 10 is a block diagram of an example workflow with a response bundle, according to some other implementations;

FIG. 11 is a block diagram of an example workflow with a response bundle, according to some further implementations;

FIGS. 12-15 are example methods for performing the workflows depicted in FIGS. 6, 10 and 11, according to some implementations;

FIG. 16 is a dataflow diagram of another workflow, according to some implementations;

FIGS. 17A-17C depict example instructions;

FIG. 18 is a block diagram of another example computing system;

FIG. 19 is a block diagram of a further example computing system; and

FIGS. 20A-20C depict an example system and workflows, according to some implementations.

### DETAILED DESCRIPTION

For illustrative purposes, specific embodiments will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

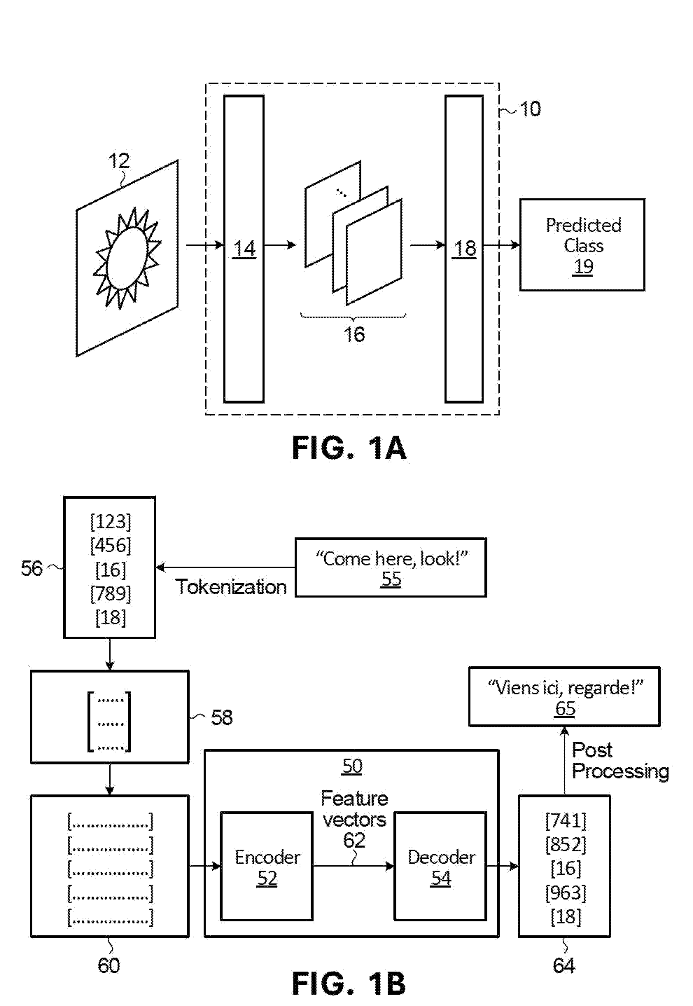

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

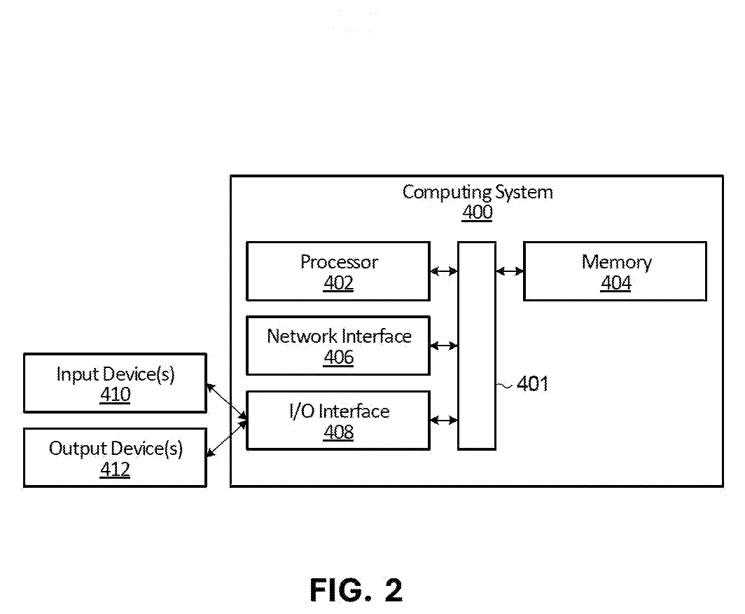

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Agentic Workflow with Response Instructions

As used herein, an AI agent is a software module capable of operating independently to accomplish a task. In many examples, the AI agent may include an LLM. As noted above, an LLM may be implemented using one or more neural networks. The LLM may be configured to receive input or a prompt and generate an output responsive to the input or prompt. In some implementations, the operation of the LLM may be constrained by providing the LLM with a tailored prompt. In other implementations, the operation of the LLM may be constrained at the output of the LLM, such that the LLM is more likely to select certain tokens or sequences of tokens. In further implementations, the operation of the LLM may be constrained by post-processing the output of the LLM, such as by using an external module to audit or revise output from the LLM.

AI agents may operate within a workflow. The workflow may describe at least one AI agent interacting with at least one computing resource to perform one or more tasks. This resource may be another AI agent or another software tool that does not necessarily involve AI, such as a database or iterative code for querying a database, a website, an analytics tool or some other module which receives input and generates output.

A workflow may also describe several AI agents and/or resources interacting with each other serially or in parallel to accomplish one or more tasks. The term “serially” indicates that an AI agent or resource may operate at a higher level of the workflow hierarchy than another AI agent or resource, while the term “in parallel” indicates that the AI agent or resource operates at the same level of the workflow hierarchy as the other AI agent or resource.

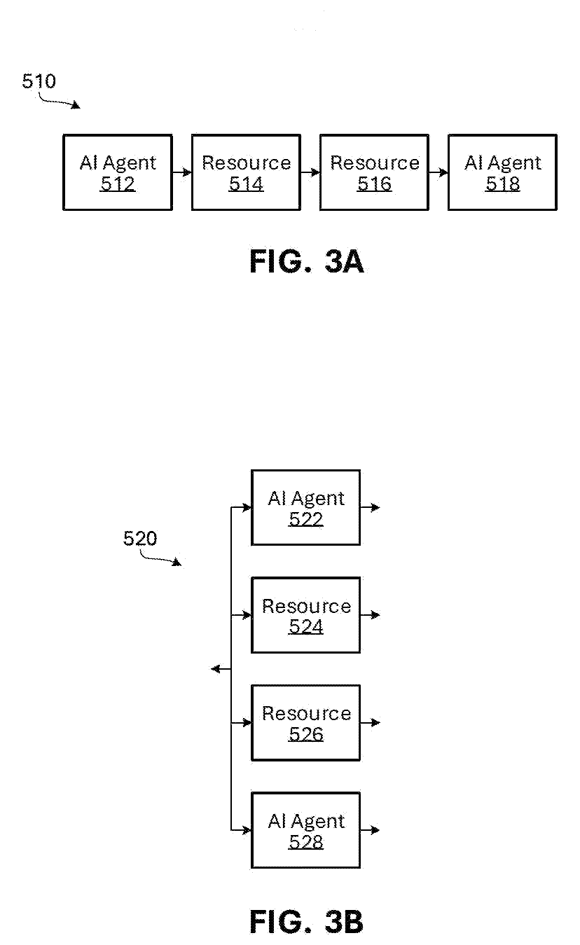

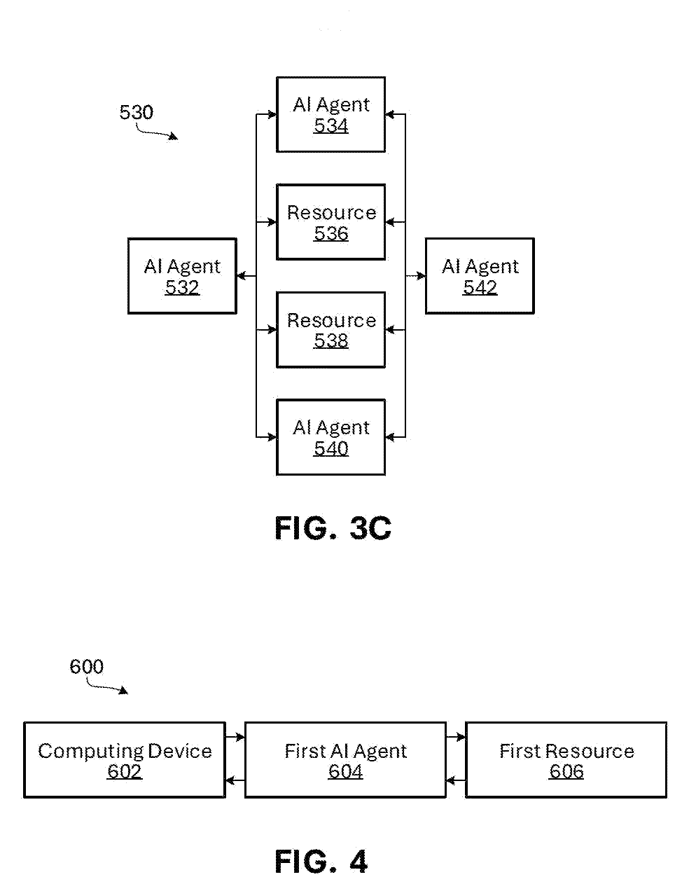

FIG. 3A depicts the block diagram of an example workflow 510, in which one or more AI agents and one or more resources are arranged serially. In particular, workflow 510 may include AI agent 512 interacting directly with resource 514. For example, AI agent 512 may provide a request or information (e.g. input) to resource 514 and/or receive a response to the request or other information from resource 514. It will be appreciated that resource 514 may also be an AI agent or another non-AI tool.

Workflow 510 may also include resource 516 and AI agent 518. Resource 514 may directly interact with resource 516 and resource 516 may directly interact with AI agent 518.

It will be appreciated that in this serial example depicted in workflow 510, AI agent 512 may not interact directly with resource 516 or AI agent 518. Similarly, resource 514 may not interact directly with AI agent 518.

Other serial arrangements may also be possible in the example workflow 510.

FIG. 3B depicts the block diagram of another example workflow 520, in which one or more AI agents and one or more resources are arranged in parallel. In particular, workflow 520 may include AI agent 522, AI agent 524, AI agent 526 and AI agent 528, which may all interact with the same source. The source may be another AI agent or resource. The source may also be a user device or some other input device. The source may provide a prompt, request or information (e.g. input) to AI agent 522, AI agent 524, AI agent 526 and/or AI agent 528. The source may also receive a response to the prompt, request or information from AI agent 522, AI agent 524, AI agent 526 and/or AI agent 528.

In some examples, the source may only interact with a subset of AI agent 522, AI agent 504, AI agent 506 and/or AI agent 508 at a time, such as only if that subset is appropriate to solve a specific problem or respond to a specific request. The workflow may also include logic to determine which subset is appropriate to solve the specific problem or response to the request. However, it will be understood that the source may be configured to interact with any of AI agent 522, AI agent 524, AI agent 526 and/or AI agent 528, such that AI agent 522, AI agent 524, AI agent 526 and/or AI agent 528 are arranged in parallel in workflow 520.

AI agent 522, AI agent 524, AI agent 526 and/or AI agent 528 may also interact with one or more other AI agents or resources, such as to provide requests or information and/or to receive responses or information. In some examples, AI agent 522, AI agent 524, AI agent 526 and/or AI agent 528 may interact with the same AI agents or resources or with different AI agents or resources.

Other parallel arrangements may also be possible in the example workflow 520.

Moreover, the serial and parallel example arrangements depicted in workflow 510 and workflow 520 may be combined, such that a workflow may include one or more AI agents and/or one or more resources interacting serially and in parallel. FIG. 3C depicts the block diagram of another example workflow 530, in which one or more AI agents are arranged in series and in parallel. For example, workflow 530 may include AI agent 532 arranged in series with AI agent 534, resource 536, resource 538, AI agent 540 and AI agent 542. AI agent 532 may only interact directly with AI agent 534, resource 536, resource 538 and AI agent 540. As well, AI agent 534, resource 536, resource 538 and AI agent 540 may be arranged in parallel. Similarly, AI agent 532, AI agent 534, resource 536, resource 538 and AI agent 540 may be arranged in series with AI agent 542, such that each of AI agent 532, AI agent 534, resource 536, resource 538 and AI agent 540 may directly interact with AI agent 542. It will be appreciated that although AI agent 532 and AI agent 542 may be arranged serially with one another, AI agent 532 and AI agent 542 may not directly interact with one another.

Other series and parallel arrangements may also be possible in the example workflow 530.

As well, the terms “system” and “architecture,” as used herein, may also be used to describe the AI agents and resources which operate within a workflow, in addition to the relationships between these AI agents and resources.

In some examples, a first AI agent may transmit requests to a first resource. Accordingly, the first resource may generate a response to the request from the first AI agent. Although the first AI agent may receive the response from the first resource, the first AI agent may not be properly configured to handle the response. For example, the first AI agent may not be properly trained to interpret or format the response from the first resource. In other examples, the response from the first resource may be insufficient, and more information from the first AI agent to the first resource or from the first resource to the first AI agent may be required for the response to be handled effectively.

Since the first AI agent may not be properly configured to handle the response received from the first resource, the first AI agent may be more likely to produce errors while generating its reply to the original message based on the response received from the first resource. For example, if the first resource does not provide sufficient information in the response, the first AI agent may be likely to include errors in its reply to the message from the computing device. Errors may include errors due to a lack of information and may include hallucination.

Although it may be possible to prompt the first AI agent with instructions about how to handle a response received from the first resource, this approach may become intractable as the complexity of the architecture increases, such as where the first AI agent and the first resource are only one of many AI agents and resources in the system or workflow. For example, the first resource may also be an AI agent, e.g. a second AI agent, which may provide a request to a second resource. It may be difficult to propagate instructions for how the second AI agent is to handle the response from the second resource in the message from the computing device to the first AI agent. This would require the first AI agent to be provided with information about the second resource, which operates further down in the workflow hierarchy, complicating the system and consuming significant computational resources (e.g. memory) as the workflow grows more complex.

As well, solutions which involve training the first AI agent on the particular resource may also become intractable as complexity increases. As the number of AI agents and/or resources increases, so do the computing resources necessary to either train the AI agents based on the different resources or to set up workflows to address edge cases.

In addition to these challenges, the workflow also functions less effectively when the first AI agent is either unequipped to handle a response from the first resource or when messages/prompts to the first AI agent must be over-engineered to ensure responses from the first resource are handled properly by the first AI agent. As developers add further complexity to the system or workflow, significant testing must be performed to ensure that edge-cases and new workflows are considered. In addition to consuming significant computational resource just to test this system, the system may still not function as effectively as it should because entire workflows must be hardcoded into the top layers of the system (e.g. at the top-level message or prompt to the first AI agent or to whichever agent instructs the workflow). Nuances of resources within the workflow may be inadvertently omitted, and the system’s performance may ultimately suffer.

One solution to these problems is to configure the workflow to provide an instruction back to the first AI agent in addition to the response from the first resource. The instruction may provide the first AI agent with more direction or information for how to interpret or handle the response from the first resource. It will be understood that rather than including this instruction with the original message from the computing device to the first AI agent, requiring the user, AI agent or tool instructing the first AI agent to have knowledge of the first resource, the first resource itself or another module may be tasked with managing this knowledge. As a result, the first AI agent and the first resource may be “decoupled” from one another. Similarly, the user, AI agent or tool instructing the first AI agent may also be decoupled from the first resource.

In some implementations, a first AI agent may transmit a request from the first AI agent to a first resource. The first AI agent may receive a response bundle responsive to the request from the first AI agent. The response bundle may include a response from the first resource to the request and an instruction for the first AI agent. The resource, another agent, and/or some other software tool may generate the response bundle responsive to the request. The first AI agent may perform an operation responsive to the response bundle, such as responsive to the instruction in the response bundle. For example, the instruction may instruct the first AI agent to handle the response from the first resource in a way specified by the instruction. The operation may include following the instruction to the first AI agent, performing an operation based on the instruction, and/or assessing the correctness or validity of the instruction. In some implementations, the first AI agent may parse the instruction from the response bundle and then handle content included in the response in a particular way based on the instruction, e.g. formatting or incorporating the content in a particular way based on the instruction. For example, the first AI agent may parse the instruction from the response bundle and perform, based on the parsed instruction, the operation using content included in the response from the first resource.

After receiving the instruction and the response from the first resource, the first AI agent may perform an operation responsive to the instruction and/or the response from the first resource.

The instruction for the first AI agent may be generated just-in-time, e.g. while the first resource is generating the response to the request. For example, the instruction for the first AI agent may be determined based on at least one of the response from the first resource, the request from the first AI agent or the identity of the first AI agent. In further examples, the first resource may be configured to generate the instruction. In other implementations, a separate module (e.g. a second resource, such as another AI agent or some other software tool) may generate the instruction for the first AI agent.

The instruction for the first AI agent may include at least one of an instruction for formatting the response, an instruction for error handling, an instruction to refer the request from the first AI agent to another resource, an instruction to provide more information to the first resource, an instruction for the first AI agent to obtain more information for the request, an instruction for the first AI agent not to perform an operation, and/or some form of task feedback for the first AI agent responsive to the request.

An instruction for formatting the response may include mark-up language, such as XML, HTML, JSON or some other formatting rules which may be standardized and/or executed by another software tool.

An instruction for error handling may indicate that the first resource cannot properly respond to the request from the first AI agent. The instruction may also identify the specific error preventing the first resource from responding to the request. For example, if the first resource queries a database for information, the instruction for error handling may indicate that the database is offline or otherwise inaccessible, or that the format of the query provided in the request from the first AI agent is syntactically incorrect. In some examples, the instruction for error handling may provide recommendations or instructions for how the first AI agent should handle the error, e.g. the first AI agent should call upon another resource to assist with the request, the first AI agent should wait one or more turns in the workflow, the first AI agent should perform some other mitigation operation, etc. In situations where the instruction for the first AI agent is an instruction for error handling, the response from the first resource may be empty or invalid, since the first resource may have encountered an error while fulfilling the request from the first AI agent.

An instruction to refer the request to another resource may, for example, indicate that another resource alone or in combination with the first resource may be necessary to respond to the request.

An instruction to provide more information to the first resource or an instruction for the first AI agent to obtain more information for the request may indicate, for example, that the first resource does not have enough information to generate an acceptable or appropriate response to the request from the first AI agent.

An instruction for the first AI agent not to perform an operation may, for example, instruct the first AI agent that the first resource was unable to find any relevant information (e.g. documents) in response to the request. The instruction may further instruct the first AI agent not to respond with its own knowledge, such as to avoid hallucination.

An instruction including task feedback may provide a suggestion or instruction for the first AI agent about how to handle the response from the first resource, how to interpret the response from the first resource and/or how to generate requests for the first resource in the future. Other forms of task feedback may also be possible.

An example instruction for the first AI agent may be in response to an analytics query request.

A further example instruction for the first AI agent may be in response to a document citations request.

As noted above, the response from the first resource to the request and the instruction for the first AI agent may be received together by the first AI agent, such as in a single data structure. For example, instead of simply receiving a response from the first resource, as in existing solutions, the first AI agent may receive a response bundle including the response from the first resource and the instruction for the first AI agent.

In some further implementations, the response bundle may also include an example, which may be an example following or based on the instruction for the first AI agent. The example may be based on the response from the first resource and the instruction for the first AI agent. For instance, if the instruction includes an instruction for formatting, the example may depict how to format a response similar to the response from the first resource using that formatting.

In some further implementations, the first AI agent may receive a message from a computing device. The computing device may be a user device, a server or some other computing device. In some examples, the message may be from a user, another AI agent or some other software tool. The first AI agent may transmit the request to the first resource responsive to receiving the message. As noted above, the first AI agent may receive the response bundle responsive to the request, and the response bundle may contain the response from the first resource to the request and the instruction for the first AI agent. As also noted above, the first AI agent may perform an operation responsive to the instruction. The first AI agent may be prompted with the response from the first resource and the instruction for the first AI agent to perform the operation. The first AI agent may generate, responsive to the prompt, a reply from the first AI agent to the message. The reply may include content from the response handled in a way specified by the instruction. The first AI agent may transmit the reply to the computing device.

In some examples, the first resource may be a software tool, such as a database, a website, an analytics tool or some other module which receives input and generates output. In other examples, the first resource may be another AI agent. In these latter examples, the first AI agent may send a request to the second AI agent, which is lower in the system or workflow’s hierarchy relative to the first AI agent.

It will be appreciated that, in response to receiving a request from a first AI agent, the first resource may also send a request to another resource, such as a second resource. The first resource may be an AI agent, such as a second AI agent. In these implementations, the first resource may transmit, to a second resource, a request from the first resource. The request from the first resource may be based on the request from the first AI agent. The first resource may receive a second response bundle responsive to the request from the first resource. The second response bundle may include a response from the second resource to the request from the first resource and an instruction for the first resource. At least one of the response from the first resource or the instruction for the first AI agent may be generated based on the second response bundle.

In some further examples, the first resource may also be an AI agent, such as a second AI agent. The second AI agent may receive a response bundle from the second resource, which may include a response from the second resource to the request from the second AI agent, as well as instructions for the second AI agent. Subsequently, the second AI agent may send another respond bundle to the first AI agent, which may include the response from the second AI agent to the request from the first AI agent and instructions for the first AI agent. In some examples, the second resource may also be an AI agent, such a third AI agent.

In some implementations, the instruction provided to the first resource (e.g. the second AI agent) along with the response from the second resource (e.g. the third AI agent) may be included in the instruction to the first AI agent. In some examples, the instruction for the first AI agent may be based on the instruction for the first resource (e.g. the second AI agent).

It will be understood that the terms “first AI agent,” “second AI agent,” “third AI agent,” “first resource” and “second resource” may be relative. Although in some examples a first AI agent may occur earlier in the workflow’s hierarchy than a second AI agent, in other examples, the first AI agent may also operate in parallel to the second AI agent in the workflow. As well, the first AI agent may also receive requests from another agent higher in the workflow’s hierarchy than the first AI agent. These comments may similarly apply to the other AI agents and resources described herein.

In some implementations, the first AI agent may use the instruction from the response bundle as an additional input prompt to the first AI agent. Receiving the instruction as an additional input prompt may force the first AI agent to prioritize and follow the instruction. For example, the instruction may be received as an additional user prompt. In other implementations, the first AI agent may receive the instruction as a system prompt.

In one particular example of the solution described herein, a merchant may request a discount code to be created, such as using a computing device. A first AI agent may receive a message from the computing device asking it to create the discount code and may send a request to a first resource to assist with this process. The first resource may be another AI agent, such as a second AI agent, which may assist with one aspect of the code-creation process. In normal operation, the first resource may respond to the first AI agent with some aspect of creating the discount code in the computer system. The response may be packaged in a response bundle with an instruction for the first AI agent, such as related to formatting the discount code. However, if the first resource encounters an error, some aspect of the request from the first AI agent is incorrect, or some further resource upon which the first resource depends upon fails (e.g. a database is offline), the first resource may provide an instruction to the first AI agent for error handling. If a response from the first resource is still provided to the first AI agent, this response may be empty or invalid. The instruction for error handling may instruct the first AI agent to direct the first AI agent or the merchant itself to a help tool, which may be better equipped to provide support in this situation. Other examples of error handling may also be possible, such as a referral to other resources in the workflow, a request for more information, etc.

In another example of the solution described herein, a merchant may request edits to its website design. The first AI agent may receive a message from the computing device asking it to make these edits to the website design, and the first AI agent may transmit a request to the first resource to perform some aspect of these edits. In this example, the first resource may make edits to code affecting the website design and render a sample of the edited page. The first resource may respond with a link to the edited page and a thumbnail of the edited page. Instructions for the first AI agent may also be provided to the first AI agent with the response, as discussed above. The instructions may provide instructions for the first AI agent to display the thumbnail of the edited page and/or instruct the first AI agent to ask certain follow up questions to the merchant or user about the edited page.

It will be appreciated that the solution described herein may overcome the scalability challenges present in existing AI agent workflows and systems. Since the first AI agent may be decoupled from resources (e.g. other AI agents and tools) lower in the hierarchy of the workflow, developers, users and even the AI agents themselves may not need to worry about problems or nuances related to other layers of the hierarchy. In many situations, an AI agent operating at one level of the hierarchy (e.g. the first AI agent) may not have control over the operation of a resource lower in the hierarchy, and so the solution described herein may allow the first AI agent to rely on the expertise of that resource without any special training or knowledge. Similarly, the developer of the AI agent may not need to worry about the inner-workers of that resource, allowing for more AI agents and resources to be added to the workflow without increasing complexity for the developer or requiring additional computational resources for edge-cases in the workflow.

As well, in existing systems, an AI agent may need to be trained on the resource to which it sends requests and from which it receives responses. However, in some examples, the AI agent may call a different resource depending on the message from the computing device it receives, such that multiple resources may be organized in parallel in the workflow. This may occur in situations where each resource is a fine-tuned AI agent tailored for a different use case. As such, that AI agent may need to be trained on each of these resources. The solution described herein may reduce the training required for the AI agent, since each resource may instruct the AI agent on how to handle the response to its request received from the resource. This may reduce computational resources needed to train the AI agents in the workflow, especially as the workflow continues to develop and grow more complex.

Compared to existing systems, the solution described herein may also increase the reliability of AI agents managing other AI agents. For example, the first AI agent may instruct a first resource, which may also be an AI agent, such as a second AI agent. Since an instruction may be provided back to the first AI agent in response to requests from the first AI agent to the second AI agent, this may provide another mechanism of feedback in the workflow, improving control. From this instruction, the first AI agent may understand how to handle responses from the second AI agent, how to handle errors encountered by the second AI agent and/or whether the second AI agent is suited to handle the request at all. Other benefits may also be possible from this instruction for the first AI agent. For example, as the number of AI agents increases in the workflow, the degree of control or complexity required for the AI agents higher in the hierarchy may not need to increase significantly, i.e. the topmost AI agent does not need to be so sophisticated that it understands how every AI agent lower in the workflow hierarchy operates. Rather, in the solution described herein, guidance may be provided along with responses from AI agents lower in the workflow hierarchy and at various steps of the workflow.

FIG. 4 depicts the block diagram of a system 600 for executing a workflow, according to some implementations. System 600 includes a computing device 602, a first AI agent 604 and a first resource 606. System 600 may also include additional or other AI agents and/or resources.

In some implementations, computing device 602 may be a user device, such as a personal computer, a mobile device or some other user-facing computing device. In some implementations, computing device 602 may be a server configured to receive input from another device, such as another user device, such as over a network, an application programming interface (API) or some other means.

First AI agent 604 is a software module capable of operating independently to accomplish a task. First AI agent 604 may include an LLM or multiple LLMs.

Computing device 602 may communicate with first AI agent 604, such as over a network (e.g. over the Internet or an intranet) or directly within the same computing system. Computing device 602 may transmit one or more messages to first AI agent 604, which may include a prompt for first AI agent 604 or other information. First AI agent may similarly transmit one or more replies to computing device 602, which may include a reply from a prompt transmitted by computing device 602 or other information.

In other implementations, computing device 602 may be cloud-based and/or may include a plurality of cooperating (e.g., cooperating via a network), computer system, such as may be found in, for example, a distributed arrangement. First AI agent 604 and first resource 606 may also be stored and/or executed within the distributed arrangement. Computing device 602 and/or the distributed arrangement may include a plurality of processors (e.g., hardware processors such as, for example, processors of cooperating computer systems). Indeed, processing of inputs by an AI agent (which may include an LLM), such as first AI agent 604, may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices, as discussed above.

First AI agent 604 may also communicate with first resource 606. As noted above, first resource 606 may be another AI agent or a non-AI tool, such as a database, website or other software tool. First AI agent 604 may transmit one or more requests from first AI agent 604 to first resource 606 or other information. First resource 606 may transmit a response to a request from first AI agent 604 or other information.

It will be appreciated that first resource 606 may also communicate with one or more other AI agents or resources, such as in series or in parallel, as discussed above. In some implementations, first resource 606 may not communicate directly with computing device 602. In other implementations, first resource 606 may also communicate directly with computing device 602.

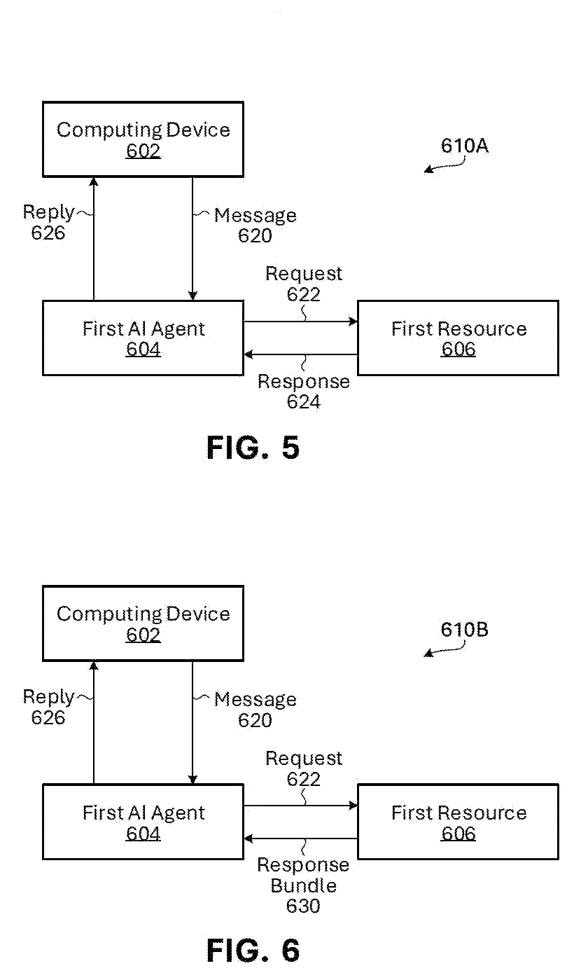

System 600 may be implemented to operate within one or more workflows. For example, FIG. 5 depicts the block diagram of a workflow 610A, which includes computing device 602, first AI agent 604 and first resource 606. It will be appreciated that workflow 610A may also include other software modules, such as AI agents and/or resources, which are not depicted.

In workflow 610A, computing device 602 transmits a message 620 to first AI agent 604. Message 620 may include a prompt or instruction for first AI agent 604, such as a prompt which instructs first AI agent 604 to perform one or more operations. Message 620 may in addition or instead include information for first AI agent 604, such as information which causes first AI agent 604 to perform one or more operations.

In some examples, message 620 may include a prompt from a user of computing device 602. In other examples, message 620 may include a prompt from one or more other AI agents, such as AI agents hosted on or in communication with computing device 602.

In response to message 620 from computing device 602, first AI agent 604 may transmit a request 622 from first AI agent 604 to first resource 606. Request 622 may include a request for information first 606, a request for resource 606 to perform one or more operations, or some other request. It will be appreciated that first AI agent 604 may generate request 622 based on message 620, and request 622 from first AI agent 604 to first resource 606 may help first AI agent 604 reply to message 620 or perform any operations stipulated by message 620 from computing device 602.

First resource 606 may receive request 622 and generate a response 624 based on request 622. For example, if request 622 includes a request to generate or provide information, this information may be included within response 624. In some further implementations, first resource 606 may interact with one or more other AI agents or resources to help generate response 624.

First resource 606 may transmit response 624 to first AI agent. First AI agent 604 may receive response 624 and generate a reply 626 to message 620 based on response 624 from first resource 606. First AI agent 604 may transmit reply 626 to computing device 602.

It will be appreciated that computing device 602 and first resource 606 do not interact directly in workflow 610A. As a result, if reply 626 includes some portion or all of response 624, computing device 602 may not be able to obtain more information directly from resource 606 to help interpret or handle response 624. Moreover, computing device 602 may not have any visibility or knowledge of first resource 606, and so computing device 602 may only understand that first AI agent 604 provided reply 626 and its contents.

Similarly, although first AI agent 604 may receive response 624 from first resource 606, first AI agent 604 may not be properly equipped or configured to handle response 624. Since the first AI agent 604 may not be properly configured to handle the response 624 received from first resource 606, first AI agent 604 may be more likely to produce errors while generating reply 626 to message 620 from computing device 602 based on response 624 received from first resource 606. For example, if first resource 606 does not provide sufficient information in response 624, first AI agent 604 may be likely to include errors in reply 626 to message 620 from computing device 602. Errors may include errors due to a lack of information and may include hallucination.

In some implementations, first AI agent 604 may be configured to send another request to first resource for additional information to supplement response 624. However, these implementations require first AI agent 604 to be aware that information is missing from response 624, which may not always be apparent to first AI agent 604. As well, these implementations may consume additional computational resources, as first AI agent 604 may be required to send an additional request to first resource 606 just to interpret response 624 from first resource 606.

As well, in some implementations, computing device 602 may provide a prompt or instruction for first AI agent 604 to request additional information from first resource 606, such as within message 620. However, these implementations may require computing device 602 to have visibility into or knowledge about first resource 606, which may be impractical as the number of AI agents and/or resources operating within the workflow increases. These supplemental instructions may also consume additional memory or computing processor, as computing device 602 may need to generate these instructions from a database or in response to external input (e.g. user input).

FIG. 6 depicts the block diagram of another workflow 610B, according to some implementations. Similar to workflow 610A, workflow 610B includes computing device 602, first AI agent 604 and first resource 606. Similarly, first AI agent 604 receives message 620 from computing device 602 and transmits request 622 from first AI agent 604 to first resource 606.

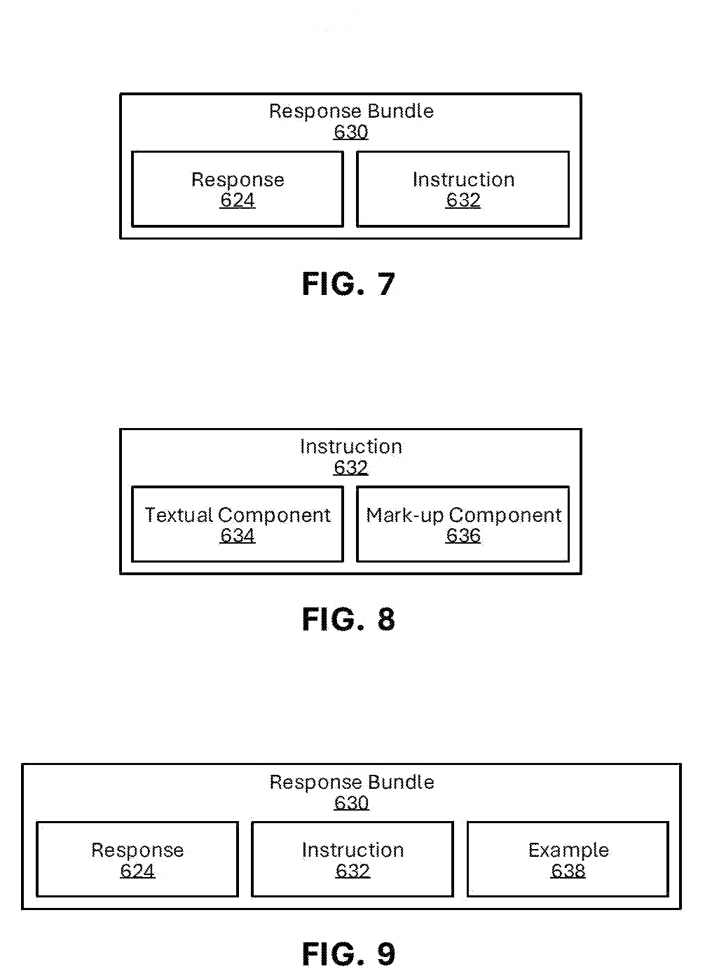

However, in workflow 610B, first AI agent 604 receives a response bundle 630 from first resource 606 instead of just response 624 from first resource 606. As depicted in FIG. 7, response bundle 630 may include response 624 and also an instruction 632 for first AI agent 604.

It will be appreciated that response 624 from first resource 606 to request 622 and instruction 632 for first AI agent 604 may be received together by first AI agent 604, such as in a single data structure (e.g. response bundle 630). For example, instead of simply receiving response 624 from first resource 606, as in workflow 610A, first AI agent 604 may receive response bundle 630 including response 624 from first resource 606 and instruction 632 for first AI agent 604. In other implementations, response bundle 630 may not be an actual data structure and first AI agent 604 may receive response 624 and instruction 632 separately, such as in separate data structures or as separate messages.

Instruction 632 may include at least one of an instruction for formatting response 624, an instruction for error handling, an instruction to refer request 622 from first AI agent 604 to another resource, an instruction to provide more information to first resource 606, an instruction for first AI agent 604 to obtain more information for request 622, an instruction for first AI agent 604 not to perform an operation, and/or some form of task feedback for first AI agent 604 responsive to request 622. Instruction 632 may include other instructions, suggestions or information in addition to or instead of those discussed above.

An instruction 632 for formatting response 624 may include mark-up language or some other formatting rules which may be standardized and/or executed by another software tool. For example, FIG. 8 depicts a block diagram of instruction 632 according to some implementations, which may include a textual component 634 and a mark-up component 636. Textual component 634 may include an instruction to follow the formatting rules specified by mark-up component 636 for response 624 or any reply 626, request or other information generated based on response 624. Mark-up component 636 may be specified in mark-up language, such as XML, HTML, JSON, or some other formatting rules. Textual component 634 may additionally or instead include one or more other instructions, such as any of those discussed above.

An instruction 632 for error handling may indicate that first resource 606 cannot properly respond to request 622 from first AI agent 604. The instruction may also identify the specific error preventing first resource 606 from responding to request 622. For example, if first resource 606 queries a database for information, the instruction 632 for error handling may indicate that the database is offline or otherwise inaccessible, or that the format of the query provided in request 622 from first AI agent 604 is syntactically incorrect. In some examples, the instruction 632 for error handling may provide recommendations or instructions for how first AI agent 604 should handle the error, e.g. first AI agent 604 should call upon another resource to assist with request 622, first AI agent 604 should wait one or more turns in workflow 610B, first AI agent 604 should perform some other mitigation operation, etc. In situations where the instruction 632 for first AI agent 604 is an instruction for error handling, response 624 from first resource 606 may be empty, null or invalid, since first resource 606 may have encountered an error while fulfilling request 622 from first AI agent 604.

An instruction 632 to refer request 622 to another resource may, for example, indicate that another resource alone or in combination with first resource 606 may be necessary to respond to request 622.

An instruction 632 to provide more information to first resource 606 or an instruction for first AI agent 604 to obtain more information for request 622 may indicate, for example, that first resource 606 does not have enough information to generate an acceptable or appropriate response 624 to request 622 from first AI agent 604.

An instruction 632 for first AI agent 604 not to perform an operation may, for example, instruct first AI agent 604 that first resource 606 was unable to find any relevant information (e.g. documents) in response to request 622. The instruction 632 may further instruct first AI agent 604 not to respond with its own knowledge, such as to avoid generating an error or a hallucination.

An instruction 632 including task feedback may provide a suggestion or instruction for first AI agent 604 about how to handle response 624 from first resource 606, how to interpret response 624 from first resource 606 and/or how to generate requests for first resource 606 in the future. Other forms of task feedback may also be possible.

In some further implementations, response bundle 630 may also include an example 638 in addition to response 624 and instruction 632, as depicted in FIG. 9. Example 638 may be an example following or based on instruction 632 for first AI agent 604. Example 638 may be based on response 624 from first resource 606 and instruction 632 for first AI agent 604. For instance, if instruction 632 includes an instruction for formatting, example 638 may explain or depict for first AI agent 604 how to format a response similar to response 624 from first resource 606 using that formatting. Example 638 may depict mark-up component 636 in instruction 632 applied to an exemplary response.

First AI agent 604 may receive example 638 as part of a user or system prompt, which may constrain the output of first AI agent 604 based on example 638. In other implementations, example 638 may be used to constrain the output of first AI agent 604, either while first AI agent 604 generates output tokens or in a post-processing routine after first AI agent 604 has generated output. Example 638 may be provided to first AI agent 604 in addition to other explanatory context, such as other details in instruction 632.

In some implementations, first resource 606 may generate response bundle 630. For example, since first resource 606 generates response 624, first resource 606 may also be configured to generate instruction 632. First resource 606 may generate instruction 632 based on response 624, such as by retrieving instruction 632 from a database (not depicted) based on response 624 (e.g. based on the content of response 624). First resource 606 may also perform analysis or processing of response 624 to generate instruction 632, such as by determining whether response 624 is complete (e.g. assessing error or status codes in response 624 or otherwise generated by first resource 606). In some implementations, first resource 606 may generate instruction 632 just-in-time, such that instruction 632 is generated responsive to first resource 606 generating response 624 based on request 622. First resource 606 may assemble response bundle 630 with response 624 and instruction 632, or first resource 622 may instruct some other software module to assemble response bundle 630 with response 624 and instruction 632 generated by first resource 606.

In implementations where response bundle 630 includes example 638, first resource 606 may also generate example 638, such as based on response 624 and/or instruction 632. First resource 606 may assemble response bundle 630 with response 624, instruction 632 and example 638, or first resource 606 may instruct some other software module to assemble response bundle 630 with response 624, instruction 632 and example 638 generated by first resource 606.

In other implementations, first resource 606 may not directly generate instruction 632. For example, first resource 606 may instruct another software module to generate instruction 632. Alternatively, another software module may intercept response 624 generated by first resource 606 and generate instruction 632 based on response 624. First resource 606 may or may not instruct this other software module to generate instruction 632 and/or package response 624 with instruction 632 in response bundle 630. It will be appreciated that this may allow existing workflows to be reconfigured to provide instructions with responses without requiring significant adaptations or reconfigurations of each resource (which may be an AI agent or some other software tool).

In some implementations, first AI agent 604 may perform an operation responsive to instruction 632 received in response bundle 630. Performing the operation may include first AI agent 604 parsing instruction 632 from response bundle 630. First AI agent 604 may perform the operation based on the parsed instruction 632, such as using content included in response 624 from first resource 606. The operation may include generating a reply responsive to message 620, generating another request to transmit to another AI agent or resource, performing a calculation or analysis, or some other operation.

In some implementations, first AI agent 604 may be prompted with response 624 from first resource 606. First AI agent 604 may also be prompted with instruction 632. The prompt may be for first AI agent 604 to perform an operation. Other information may also be included within the prompt.

Receiving instruction 632 as an additional input prompt to first AI agent 604 may force first AI agent 604 to prioritize and follow instruction 632. For example, instruction 632 may be received as an additional user prompt. In other implementations, first AI agent 604 may receive instruction 632 as a system prompt.

In other implementations, first AI agent 604 may not receive instruction 632 as a prompt. However, first AI agent 604 may be constrained by instruction 632 using some other mechanism. In these implementations, first AI agent 604 may or may not receive response 624 as an input prompt as well.

First AI agent 604 may also generate reply 626 to message 620 received from computing device 602, such as responsive to a prompt of first AI agent 604 with response 624 and instruction 632. Reply 626 may include content from response 624 handled in a way specified by instruction 632 by first AI agent 604. First AI agent 604 may transmit the reply to computing device 602.

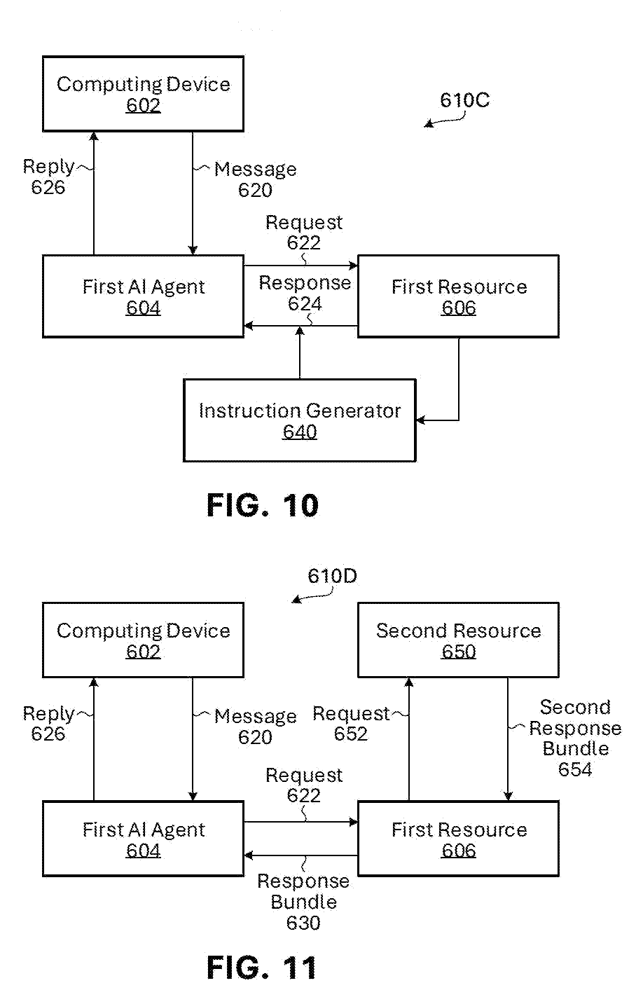

FIG. 10 depicts a block diagram of another workflow 610C, which includes an instruction generator 640 for generating instruction 632. Workflow 610C is otherwise identical to workflow 610B. In some implementations, instruction generator 640 may receive a request or instruction from first resource 606 to generate instruction 632. First resource 606 may provide response 624 to instruction generator 640. Alternatively, first resource 606 may not provide response 624 to instruction generator 640, and first resource 606 may instead provide instruction generator 640 with just with a request to generate instruction 632. In some further examples, first resource 606 may also provide instruction generator 640 with context to assist with the generation of instruction 632, in addition to or instead of providing response 624 to instruction generator 640.

In some other examples, instruction generator 640 may intercept response 624 before generating instruction 632 and/or assembling response bundle 630. First resource 606 may or may not have knowledge or visibility of instruction generator 640, and so instruction generator 640 may be configured to determine when first resource 606 has generated or transmitted response 624 before intercepting response 624. As used herein, the term “intercepting” may include any action by instruction generator 640 which was not initiated by first resource 606, such that first resource 606 did not instruct or direct instruction generator 640 to generate instruction 632. In some examples, instruction generator 640 may query first resource 606 for response 624 or other information, after which instruction generator 640 may generate instruction 632 based on response 624 or that other information.

Instruction generator 640 may generate instruction 632 by performing analysis or a determination based on response 632 and/or other information received from first resource 606. For example, instruction generator 640 may perform analysis or processing of response 624 to generate instruction 632, such as by determining whether response 624 is complete (e.g. assessing error or status codes in response 624 or otherwise generated by first resource 606). Instruction generator 640 may also retrieve some or all of instruction 632 from a database (not depicted), such as based on the content of response 624.

Instruction generator 640 may generate instruction 624 and/or assemble response bundle 630 just-in-time, such as responsive to receiving or intercepting response 624 from first resource 606.

In some further examples, instruction generator 640 may intercept request 622 from first AI agent 604. Instruction generator 640 may generate some or all of instruction 632 based on request 622, and instruction generator 640 may complete generating instruction 632 and/or response bundle 630 based on response 624 intercepted or received from first resource 606 by instruction generator 640.

In some implementations, instruction generator 640 may be included within or performed by first resource 606 or first AI agent 604.

Other implementations of instruction generator 640 may also be possible.

In some further implementations, response bundle 630 may be validated before first AI agent 604 receives response bundle 630. For example, response 624 and/or instruction 632 may be validated. Example 638 may also or instead be validated. Validating response bundle 630 may include confirming that no errors or no obvious errors are present in response bundle 630, redacting certain information from response bundle 630 (e.g. from response 624), confirming that first AI agent 604 and/or first resource 606 have proper permissions or authentication for any content in response bundle 630, and/or other validation tasks. For example, validation may confirm that instruction 632 within response bundle 630 is appropriate for first AI agent 604, such as complying with certain policies or permissions of the workflow. First source 606 may or may not be permitted to provide certain content in response 624 to first AI agent 604, such as depending on the identify of first AI agent 604 and/or first resource 606, and/or the content of request 622 and/or response 624.

First resource 606, first AI agent 604 and/or instruction generator 640 may validate response bundle 630. In other implementations, another module may validate response bundle 630 before it is received by first AI agent 604.

FIG. 11 depicts the block diagram of another workflow 610D, which includes computing device 602, first AI agent 604 and first resource 606. However, workflow 610D also includes a second resource 650, which may be another AI agent or some other software tool, such a non-AI software tool. Workflow 610D may be otherwise identical to workflow 610B and/or workflow 610C.

As described with respect to workflow 610B above, first resource 606 may receive request 622 from first AI agent 604. To generate response 624 to request 622, first resource 606 may transmit a request 652 to second resource 650. Request 652 from first resource 606 may be based on request 622 from first AI agent 604. For example, first resource 606 may parse or perform analysis based on request 622 from first AI agent 604 to determine request 652 from first resource 606. In addition or instead, first resource 606 may generate a response to request 622 but, after generating the response, determine that more information is necessary to generate a complete or appropriate response to request 622. Subsequently, first resource 606 may generate request 652 based on the partial response to request 622 from first AI agent 604 and/or request 622.

In some implementations, first resource 606 may select which of one or more resources to send request 652 based on request 622 from first AI agent 604. For example, a particular resource, such as second resource 650, may be best equipped or configured to handle request 652 from first resource 606.

Second resource 650 may receive request 652 from first resource 606. Second resource 650 may generate a second response bundle 654 based on request 652. Second response bundle 654 may include a response from second resource 650 to request 652 and an instruction for first resource 606. It will be appreciated that the instruction may not be for first AI agent 604. However, in some further implementations, the instruction may in addition or instead be for first AI agent 604.

In some further implementations, second resource 650 may transmit a further request to another resource before generating second response bundle 654.

In some further implementations, second resource 650 may not generate second response bundle 654, but may instead transmit only a response from second resource 650 to request 652 to first resource 606.

Second response bundle 654 may be generated by second resource 650. In some other implementations, instruction generator 640 and/or another instruction generator may generate second respond bundle 654. For example, the instruction generator may receive or intercept the response from second resource 650, generate an instruction for first resource 606 based on the response and package the response and instruction in second response bundle 654.

In some implementations, second response bundle 654 may also include an example, as described above. The example may be based on the instruction for first resource 606, also include in second response bundle 654.

First resource 606 may receive second response bundle 654 responsive to request 652 from first resource 606. First resource 606 may generate at least one of response 624 from first resource 606 or instruction 632 for first AI agent 604 based on second response bundle 654. For example, response 624 from first resource 606 and/or instruction 632 for first AI agent 604 may be generated based on the response from second resource 650 and the instruction for first resource 606 from second resource 650.

As described above with respect to workflow 610B and/or workflow 610C, first resource 606 may generate response 624 to request 622. First AI agent 604 may receive response bundle 630 with response 624 and instruction 634, and first AI agent 604 may generate reply 626 from first AI agent 604 to computing device 602, which first AI agent 604 may transmit to computing device 602.

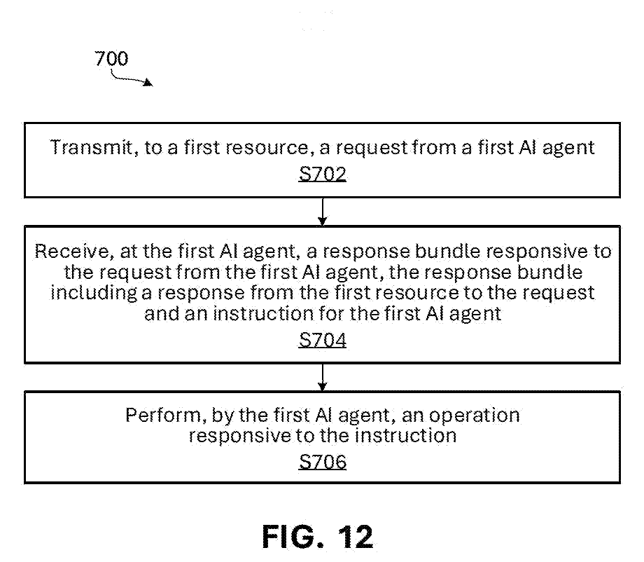

FIG. 12 depicts a method 700, which may be performed by system 600. Method 700 may be performed by at least one processing unit, which might or might not be distributed.

At step S702, a request from a first AI agent is transmitted to a first resource.

For example, request from the first AI agent may be request 622 from first AI agent 604. Request 622 may be transmitted to first resource 606.

At step S704, a response bundle responsive to the request from the first AI agent is received at the first AI agent. The response bundle includes a response from the first resource to the request and an instruction for the first AI agent.

For example, first AI agent 604 may receive response bundle 630 responsive to request 622 from first AI agent. Response bundle 630 may include response 624 from first resource 606 and instruction 632.

Instruction 632 may be an instruction for formatting response 624, an instruction for error handling, an instruction to refer request 622 from the first AI agent to another resource, an instruction to provide more information to first resource 606, an instruction for first AI agent 604 to obtain more information, an instruction for first AI agent 604 not to perform an operation, or task feedback for first AI agent 604 responsive to request 622.

Instruction 632 for first AI agent 604 may be determined based on response 624 from first resource 606. Other information from first resource 606 or other sources may also be used to determine instruction 632. For example, instruction 632 may be retrieved from a database or generated using some other means or calculations. Instruction 632 may be generated or retrieved just-in-time, such as response to response 624.

In some implementations, response bundle 630 may be generated by first resource 606. In other implementations, response bundle 630 may be generated by another software tool, such as instruction generator 640. For example, instruction generator 640 receive or intercept response 624 generated by first resource 606 and may generate instruction 632 based on response 624. Instruction generator 640 may assemble response bundle 630.

First resource 606 may be another AI agent or some other software tool, such as a non-AI software tool like a database or website.

In some further implementations, response bundle 630 may also include an example, such as example 638. Instruction generator 640 or first resource 606 may generate example 638.

Response bundle 630 may also be validated, such as by first AI agent 602, first resource 606, instruction generator 640 and/or another software module. For example, response 624 and/or instruction 632 may be validated. Example 638 may also or instead be validated. Validating response bundle 630 may include confirming that no errors or no obvious errors are present in response bundle 630, redacting certain information from response bundle 630 (e.g. from response 624), confirming that first AI agent 604 and/or first resource 606 have proper permissions or authentication for any content in response bundle 630, and/or other validation tasks.

At step S706, the first AI agent performs an operation responsive to the instruction.

For example, first AI agent 604 may perform an operation responsive to instruction 632. The operation may include generating a reply responsive to message 620, generating another request to transmit to another AI agent or resource, performing a calculation or analysis, or some other operation. For example, the operation may include generating reply 626 for computing device 602, such as based on response bundle 630.

It will be appreciated that method 700 may include additional or fewer steps than those discussed above.

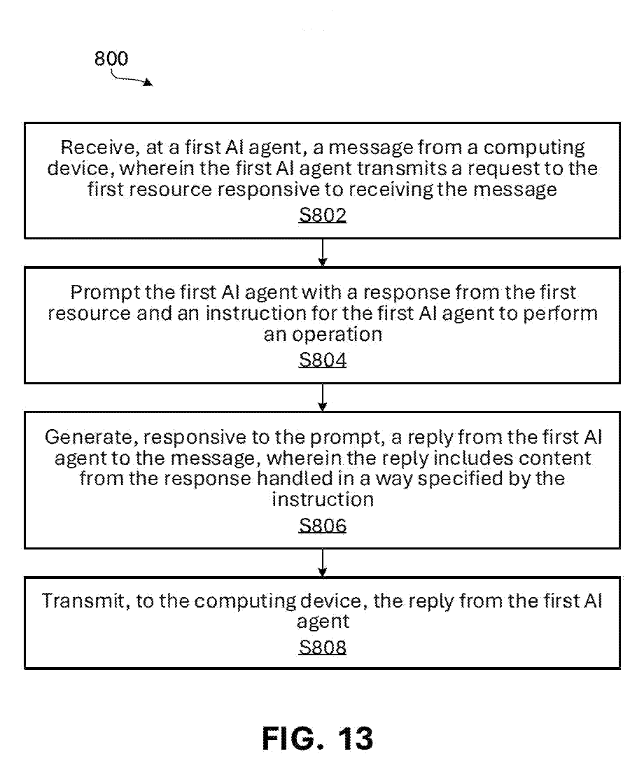

FIG. 13 depicts another method 800, which may be performed by system 600. Method 800 may be performed by at least one processing unit, which might or might not be distributed. Method 800 may be combined and/or performed with method 700, such that one or more steps in method 800 may be performed before or after one or more steps in method 700.

At step S802, a first AI agent receives a message from a computing device, and the first AI agent transmits a request to the first resource responsive to receiving the message.

For example, first AI agent 604 may receive message 620 from computing device 602. First AI agent 604 may transmit request 622 to first resource 606 responsive to receiving message 620.

Message 620 may include a prompt or instruction for first AI agent 604, such as a prompt which instructs first AI agent 604 to perform one or more operations. Message 620 may in addition or instead include information for first AI agent 604, such as information which causes first AI agent 604 to perform one or more operations.

At step S804, the first AI agent is prompted with a response from the first resource and an instruction for the first AI agent to perform an operation.

For example, first AI agent 604 may be prompted with response 624 from first resource 606 and instruction 632 for first AI agent 604. Response 624 and instruction 632 may be contained in response bundle 630.

It will be appreciated that step S702 and/or S704 from method 700 may be performed before step S804 in method 800, such that first AI agent 604 receives response bundle 630.

First AI agent 604 may perform the operation responsive to instruction 632, as described in method step S707 in method 800. The operation may include one or more operations, such as generating a reply responsive to message 620, generating another request to transmit to another AI agent or resource, performing a calculation or analysis, or some other operation. For example, the operation may include generating reply 626 for computing device 602, such as based on response bundle 630.

In some further examples, the prompt may also include additional information included in response bundle 630, such as example 638.

At step S806, a reply is generated, responsive to the prompt, from the first AI agent to the message, wherein the reply includes content from the response handled in a way specified by the instruction.

For example, reply 626 from first AI agent 604 may be generated responsive to the prompt described in step S804, such as after the prompt is received by first AI agent 604. Reply 626 may include content from response 624 handed in a way specified by instruction 632. Some or all of response 626 may be included in reply 626.

In some examples where instruction 632 includes an instruction for formatting some or all of response 624, reply 626 may include content of response handled or formatted in a way specified by instruction 636.

In other examples where instruction 632 includes an instruction for error handling, reply 626 may include null or empty content included in response 626 or an error message specified by instruction 632. It will be appreciated that in these examples, the content of response 626 may be empty. In other example wherein instruction 632 includes an instruction for error handling, reply 626 may only be generated after first AI agent 604 has repeated request 622 to obtain a fulsome or correct response from first resource 606 or another AI agent or resource to be provided to computing device 602 in reply 626. It will be appreciated, however, that reply 626 may also not be generated in these examples until the error specified by instruction 632 is corrected, such as by first AI agent 604 and/or another AI agent or resource. As well, in alternate examples, reply 626 may be generated without including any content from response 624, depending on the error handling instruction specified by instruction 632.

In further examples where instruction 632 includes an instruction to refer request 622 to another resource, an instruction to provide more information to first resource 606, and/or an instruction for first AI agent 604 to obtain more information, reply 626 may include a request specified by instruction 632 for more information or additional instructions, as well as a summary of the partial or incomplete content in response 622. It will be appreciated, however, that reply 626 may also not be generated in these examples until more information or a more complete response to a revised request from first AI agent 604 is obtained.

In further examples where instruction 632 includes an instruction for first AI agent 604 not to perform an operation, reply 626 may include content from this instruction in addition or instead of content from response 624.

In further examples, reply 626 may include additional information included in response bundle 630, such as content from example 638.

It will be appreciated that in further examples, instruction 632 may specify how first AI agent 604 should handle the content in response 624, such as which content in response 624 should be included in reply 626, how the content in response 624 should be formatted in reply 626, whether additional information is required in reply 626 in addition to some or all of the content of response 624, and/or other specifications not listed here.

At step S808, the reply is transmitted from the first AI agent to the computing device.

For example, reply 626 may be transmitted from first AI agent 604 to computing device 602. A user and/or some other system or server may receive reply 626 and generate a new message for first AI agent 604 and/or another AI agent based on reply 626.

It will be appreciated that method 800 may include additional or fewer steps than those discussed above.

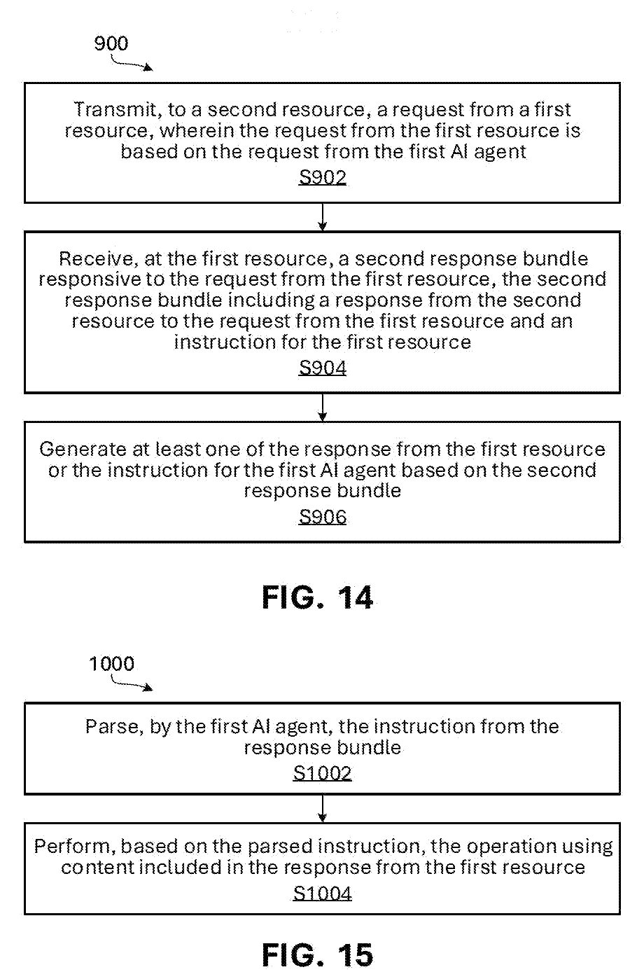

FIG. 14 depicts another method 900, which may be performed by system 600. Method 900 may be performed by at least one processing unit, which might or might not be distributed. Method 900 may be combined and/or performed with some or all of method 700 and/or method 800, such that one or more steps in method 900 may be performed before or after one or more steps in method 700 and/or method 800.

It will be appreciated that system 600 may also include additional AI agents and/or resources than those depicted in FIG. 4.

At step S902, a request from a first resource is transmitted to a second resource, wherein the request from the first resource is based on the request from the first AI agent.

For example, request 652 from first resource 606 may be transmitted to second resource 650. Request 652 from first resource 606 may be based on request 622 from first AI agent 604, which may have been received by first resource 606.

In some examples, request 652 from first resource 606 may be identical to request 622 from first AI agent 604. In other examples, request 652 may include some or all of the content of request 622, and/or may include some or all of the content of request 622 after it has been transformed or altered according to the configurations of first resource 606 and/or second resource 650.

It will be appreciated that step S702 in method 700 may have been performed before step S902, such that first resource 606 received request 622 from first AI agent.

In further implementations, step S802 in method 800 may also have been performed before step S902, such that first AI agent 604 received message 620 from computing device 602, wherein first AI agent 604 transmitted request 622 to first resource 606 in step S702 responsive to receiving message 620.

In some implementations, first resource 606 and/or second resource 650 may be an AI agent.

At step S904, a second response bundle is received at the first resource, responsive to the request from the first resource. The second response bundle includes a response from the second resource to the request from the first resource and an instruction for the first resource.

For example, second response bundle 654 may be received at first resource 606, responsive to request 652 from first resource 606. Second response bundle 654 may include a response from second resource 650 to request 652 from first resource 606 and an instruction for first resource 606. The instruction for first resource 606 may include instructions for handling the response from second resource 650.

In some implementations, the instruction for first resource 606 may include an instruction for an instruction for the formatting response from second resource 650, an instruction for error handling, an instruction to refer request 652 to another resource, an instruction to provide more information to second resource 650, an instruction for first resource 606 to obtain more information for request 652, an instruction for first resource 606 not to perform an operation, and/or some form of task feedback for first resource 606 responsive to request 652. The instruction may include other instructions, suggestions or information in addition to or instead of those discussed above.

The instruction for first resource 606 may be generated by second resource 650 and/or some other entity, such as an instruction generator (e.g. instruction generator 640). The instruction generator may be instructed by second resource 650 to generate the instruction for first resource 606 and/or package second response bundle 654. Alternatively, the instruction generator may intercept request 652 and/or the response from second resource 650, after which the instruction generator may generate the instruction for first resource 606 and/or package second response bundle 654.

In some further implementations, second resource 650 may have sent a further request to another AI agent or resource to help generate the response to request 652 and/or any response bundle 654.

In some further examples, second response bundle 654 may also include an example based on the instruction for first resource 606.

At step S906, at least one of the response from the first resource or the instruction for the first AI agent are generated based on the second response bundle.

For example, at least one of response 624 from first resource 604 or instruction 632 for first AI agent 602 may be generated based on second response bundle 654, such as based on the response to request 654, the instruction for first resource 606 and/or an example included in second response bundle 654.

In some examples, response 624 from first resource 604 may be identical to the response from second resource 650. In other examples, response 624 may include some or all of the content of the response from second resource 650, and/or may include some or all of the content of the response from second resource 650 after it has been formatted or configured according to the instruction for first resource 606 included in second response bundle 654.

In some examples, instruction 632 may also include some or all of the instruction or instructions included within second response bundle 654. In these examples, the format, language or some details of the instruction included within second response bundle 654 may be altered in instruction 632.

It will also be appreciated, however, that the instruction in second response bundle 654 may only be directed to first resource 606, with which second resource 650 directly interacts. As such, the instruction in second response bundle 654 may not be appropriate for instruction 632 for first AI agent 604, as second resource 650 and/or the instruction generator which may have generated the instruction in second response bundle 654 may not have any knowledge or visibility of first AI agent 604. In these examples, instruction 632 for first AI agent 604 may not be based on the instruction for first resource 606 included in second response bundle 654.

In further examples, however, where response 624 includes some or all of the content of the response to request 652 in second response bundle 654, since the instruction for first resource 606 in second response bundle 654 also specifies handling instructions for the response to request 652, instruction 632 may also be based on the instruction for first resource 606. In this way, any special handling instructions for the responses received by first resource 606 and/or first AI agent 604 may be propagated up the workflow.

In some further implementations, step S704 and step S706 in method 700 may be performed after step S906 in method 900. For example, first AI agent 604 may receive response bundle 630 responsive to request 622 from first AI agent. Response bundle 630 may include response 624 from first resource 606 and instruction 632. As noted above, at least one of response 624 and instruction 632 may be based on response bundle 654. First AI agent 604 may also perform an operation response to instruction 632.

In further implementations, step S804, step S806 and step S808 in method 800 may also be performed after step S906 in method 900. For example, first AI agent 604 may be prompted with response 246 from first resource 606 and instruction 632 for first AI agent 604. As noted above, at least one of response 624 and instruction 632 may be based on response bundle 654. Reply 626 from first AI agent 604 may also be generated responsive to the prompt described in step S804, such as after the prompt is received by first AI agent 604. Reply 626 may include content from response 624 handed in a way specified by instruction 632. Reply 626 may then be transmitted from first AI agent 604 to computing device 602.

It will be appreciated that method 900 may include additional or fewer steps than those discussed above.

FIG. 15 depicts a method 1000 for performing step S706 in method 700, and in particular for performing, by the first AI agent, an operation response to the instruction. Method 1000 may be performed by system 600. Method 1000 may be performed by at least one processing unit, which might or might not be distributed.

At step S1002, the first AI agent parses the instruction from the response bundle.

For example, first AI agent 604 may parse instruction 632 from response bundle 630. Parsing may include extracting keywords, removing extraneous or unneeded characters, re-formatting, interpreting by use of an LLM or other interpretive tool, and/or standard parsing techniques.

In some examples, parsing may include isolating, separating and/or extracting textual component 634 from instruction 632 and/or mark-up component 636. First AI agent 604 may interpret textual component 634 different than mark-up component 636, e.g., mark-up component 636 may be interpreted according to textual component 634. In these situations, it may be desirable for textual component 634 and mark-up component 636 to be separate identified in instruction 632.

At step S1004, the operation may be performed based on the parsed instruction and using content included in the response from the first resource.

For example, the content may have been included in response 624 from first resource 606. In situations where instruction 632 is an instruction for formatting response 624, the parsed instruction 632 may include isolated textual component 634 and isolated mark-up component 636. The operation performed by first AI agent 604 may include formatting some or all of the content of response 624 according to textual component 634 and using a template specified by or conforming to mark-up component 634.

In other examples where instruction 632 includes an instruction for error handling, parsed instruction 632 may identify a specific error (such as one specified in one or both of textual component 634 or mark-up component 636, which may be isolated from instruction 632). The operation may include responding to the error, and may include listing the content included in response 624, identifying errors in the content of response 624, correcting errors in the content of response 624, and/or other error handling operations (e.g., error logging, error correction and revised attempts).

In other examples where instruction 632 includes an instruction to refer request 622 to another resource, an instruction to provide more information to first resource 606, and/or an instruction for first AI agent 604 to obtain more information, the parsed instruction 632 may identify a target (e.g. another AI agent or resource) for more information and/or information that is required. As well, the operation may include making a request of this target for additional information, and potentially identifying information missing compared to the content included in response 624 from first resource 606.

It will be appreciated that method 1000 may include additional or fewer steps than those discussed above.

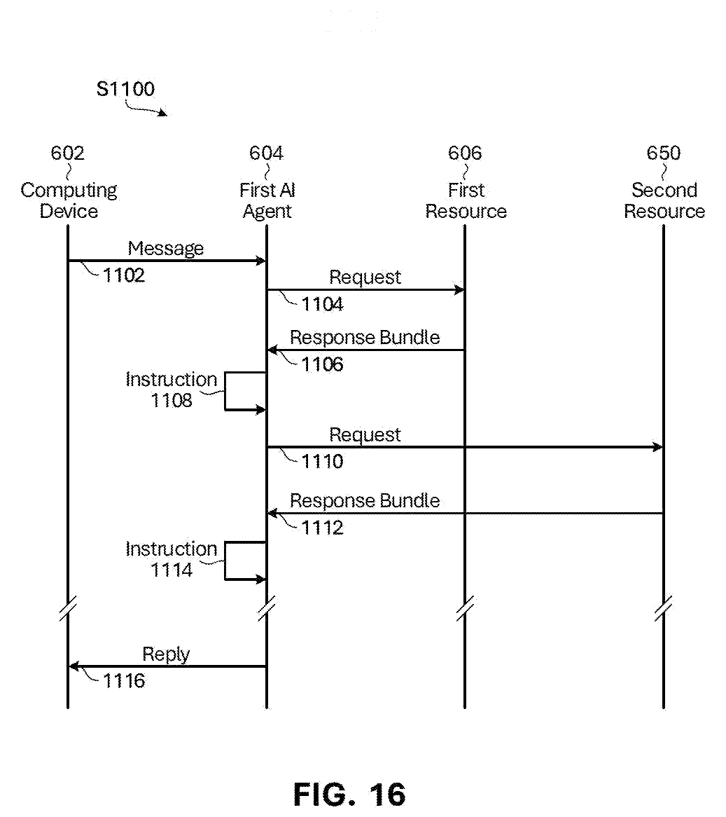

FIG. 16 depicts a dataflow diagram of another example workflow, which may include similarities to workflow 610B and/or workflow 610D.

Computing device 602 may send a message 1102 to first AI agent 604.

Responsive to message 1102, first AI agent 604 may send a request 1104 to first resource 606.

First resource 606 may respond with a response bundle 1106, which may include a response to request 1104 and an instruction 1108. As discussed previously, response bundle 1106 may be generated in part or in full by first resource 606. In other implementations, response bundle 1106 may be package or assembled by another entity, such as instruction generator 640. In these implementations, instruction 1108 may be generated by instruction generator 640. First resource 606 may have instructed or requested instruction generator 640 to generate instruction 1108 and/or package response bundle 1106. Alternatively, instruction generator 640 may have intercepted request 1104 and/or response to request 1104 and generated instruction 1108 responsive to that interception. It will be appreciated that where instruction generator 640 generates instruction 1108 and/or packages response bundle 1106, first AI agent 604 may not receive response bundle 1106 directly from first AI agent 604.

First AI agent 604 may perform an operation responsive to instruction 1108. In some implementations, instruction 1108 may be provided to first AI agent 604 as a user or system prompt, such that first AI agent 604 prioritizes instruction 1108. In other implementations, first AI agent 604 may be constrained by instruction 1108 using other mechanisms, such as by constraining the output of first AI agent 604 while first AI agent 604 generates the output (e.g. constraining tokens generated and/or selected by first AI agent 604) or by post-processing the output of first AI agent 604 using instruction 1108.

Responsive to instruction 1108, first AI agent 604 may send a request 1110 to second resource 650. For example, instruction 1108 may have instructed first AI agent 604 that more information is required to reply to message 1102 from computing device 602. Alternatively, instruction 1108 may have instructed first AI agent 604 how to handle response to request 1104, such as how to format the response, and first AI agent 604 may now be making a new request 1110 to second resource 650 to perform further operations on that response. In particular, request 1110 to second resource 650 may include some or all of the content of the response from first resource 606. Other examples of request 1110 are possible depending on the content of message 1102, the content of request 1104 and the response to that request, as well as the specific details of first AI agent 604, first resource 606 and/or second resource 650.

Second resource 650 may response with response bundle 1112, which may include a response to request 1110 and instruction 1114. As already discussed above, in other implementations, instruction 1114 may be generated by another entity instead of second resource 650, such as by instruction generator 640 or another instruction generator. As well, response bundle 1112 may be assembled or package by another entity, such as by instruction generator 640, another instruction generator or some further entity or software tool. In these implementations, response bundle 1112 may not be received by first AI agent 604 directly from second resource 650.

First AI agent 604 may perform some operation response to instruction 1114. As noted previously, instruction 1114 may be provided as a system or user prompt to first AI agent 604, or may be applied in some other way which constrains the output of first AI agent 604.

The process described above may be repeated with one or more additional AI agents and resources, and first resource 606 and/or second resource 650 may also make requests to other AI agents and/or resources. Eventually, first AI agent 604 may generate a reply 1116 to computing device 602, which may reply to message 1102. Reply 1116 may be based on one or more of the response to request 1104, the response request 1110, instruction 1108, instruction 1114 and/or any other response, instructions or information obtained throughout the workflow.

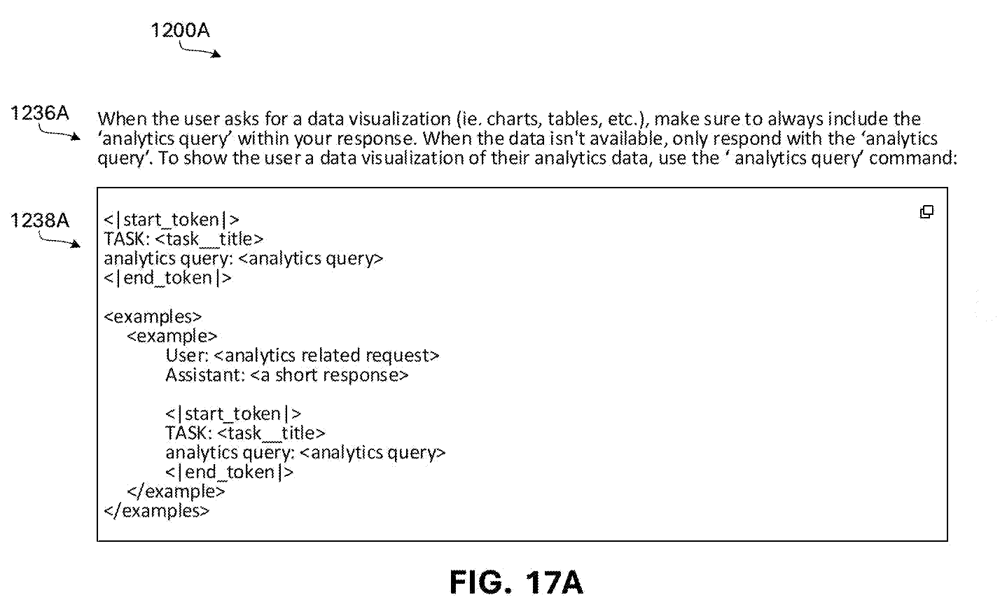

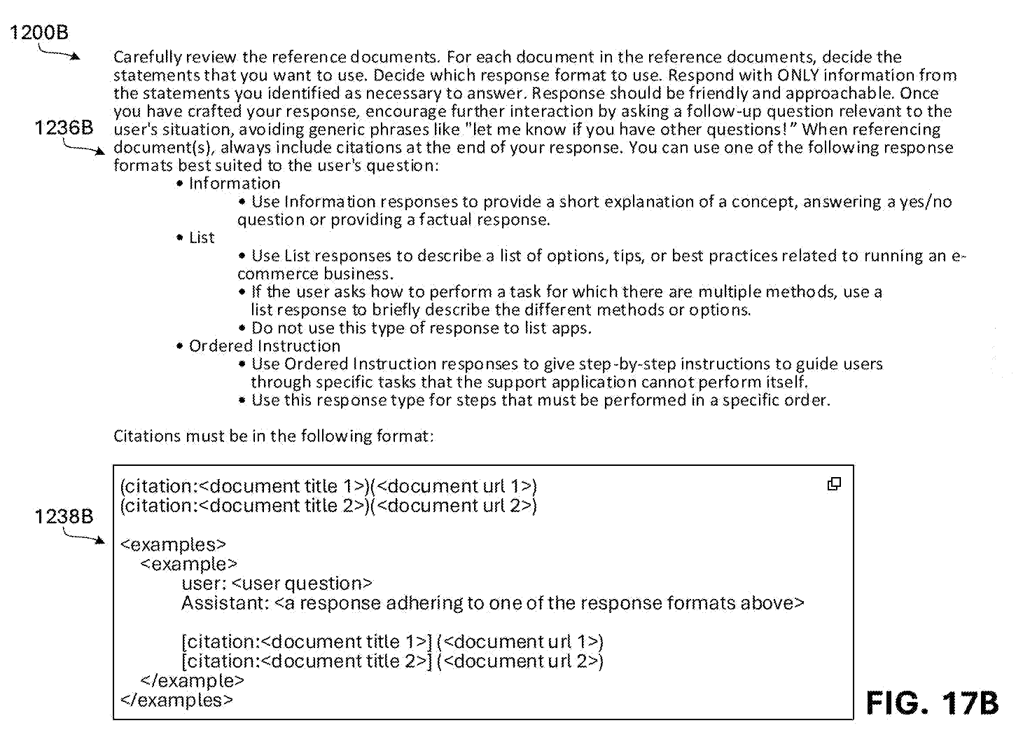

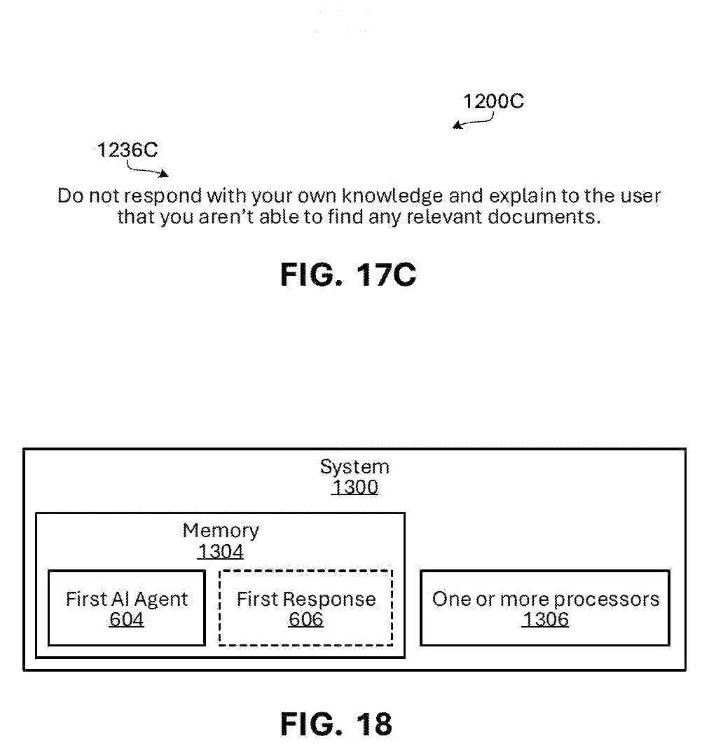

FIG. 17A depicts an example instruction 1200A, such as an instruction for first AI agent 604 or first resource 606. Instruction 1200A includes a textual component 1236A and a mark-up component 1238A. Example instruction 1200A may be in response to an analytics query request, such as a request made by first AI agent 604 or a request made by first resource 606.

Textual component 1236A may provide an instruction for when mark-up component 1238B should be applied and to what. For example, textual component 1236A may specify that when the user asks for a data visualization, the analytics query should be included with the response. Textual component 1236A may also specify how responses should appear when data isn’t available and how a data visualization of analytics data should be obtained, such as with an analytics query command specified by mark-up component 1238A.

Mark-up component 1238A may include one or more mark-up languages, such as XML, HTML, JSON, or some other formatting rules. For example, mark-up component 1238A may specify the formatting of an analytics query command. The analytics query command may also be used in a further request, such as a further request performed by first AI agent 604.

FIG. 17B depicts another example instruction 1200B, such as an instruction for first AI agent 604 or first resource 606. Instruction 1200B also includes a textual component 1236B and a mark-up component 1238B. Example instruction 1200B may be in response to a document citations request, such as a request made by first AI agent 604 or a request made by first resource 606.

Textual component 1236B may specify how documents should be reviewed and what content should be included within responses, as well as other related constraints. Textual component 1236B may also specify that citations must be presented in the format specified by mark-up component 1238B, which may include one or more mark-up languages or other formatting rules.

FIG. 17C depicts another example instruction 1200C, such as an instruction for first AI agent 604 or first resource 606. In this example, instruction 1200C only includes a textual component 1236C. For example, textual component 1236C provides an instruction for first AI agent 604 not to perform a certain operation, and in particular not to respond with its own knowledge. As well, textual component 1236C also provides an instruction for first AI agent 604 to perform a specific operation, an in particular to explain to the user that it was not able to find any relevant documents.

Other example instructions may include referring first AI agent 604 to another resource, such as a help tool, in response to a certain request. For example, first AI agent 604 my request first resource 606 generate some aspect of a website. First AI agent 604 may generate a portion of the website, but first AI agent 604 may be unable to generate a specific aspect of the website. Response 624 to first AI agent 604 may include a mark-up component representing the HTML of the website. However, instruction 632 may refer first AI agent to another resource, such as the help tool or a help website, which may include another AI agent, to complete the request (e.g., complete generating the website).

FIG. 18 illustrates an example of a system 1300. System 1300 may be used in any of workflow 610A, workflow 610B, workflow 610C and/or workflow 610D. As well, system 1300 may be used in any of methods 700, 800, 900 and/or 1100.

System 1300 includes a memory 1304 and one or more processors 1306. Memory 1304 includes a first AI agent 604. By “storing” first AI agent 604, it is meant that the parameters and other values that make up first AI agent 604 and that are required for execution of first AI agent 604 are stored. The parameters depend upon how first AI agent 604 is implemented. For example, assuming first AI agent 604 utilizes one or more neural networks and/or one or more LLMs, the weights and biases of the one or more neural networks and/or one or more LLMs are stored.

First AI agent 604 may have been trained on a generic data set, such as a large corpus of text, images or other data. First AI agent 604 may include at least one LLM. The LLM may have the example LLM structure described earlier in relation to FIG. 1B, or it may have another structure, e.g. it may only implement a decoder or an encoder, rather than both. The exact structure of the LLM is implementation specific.

One or more processors 1306 may execute first AI agent 604. One or more processors 1306 may each be implemented as a processor that executes instructions stored in memory, or it/they may be or include dedicated integrated circuits, such as one or more field programmable gate arrays (FPGAs) and/or one or more application-specific integrated circuits (ASICs). One or more processors 1306 may be or include one or more processing cores. One or more processors 1306 may be or include one or more processing cores on a GPU.

In some implementations, memory 1304 may also store first resource 606. As noted previously, first resource 606 may be another AI agent or a non-AI software tool, such as a database, analytics tool or other software module. First resource 606 may also be a classifier or some other machine learning tool. The parameters, repositories, software modules and other aspects of first resource 606 required for execution of first resource 606 may also be stored in memory 1304.

Memory 1304 may also store one or more other AI agents or resources. However, in other implementations, first resource 606 and/or one or more other AI agents or resources may be stored on a separate memory (not depicted) and accessible by system 1300, memory 1304, one or more processors 1306 and/or first AI agent 604 over a network.

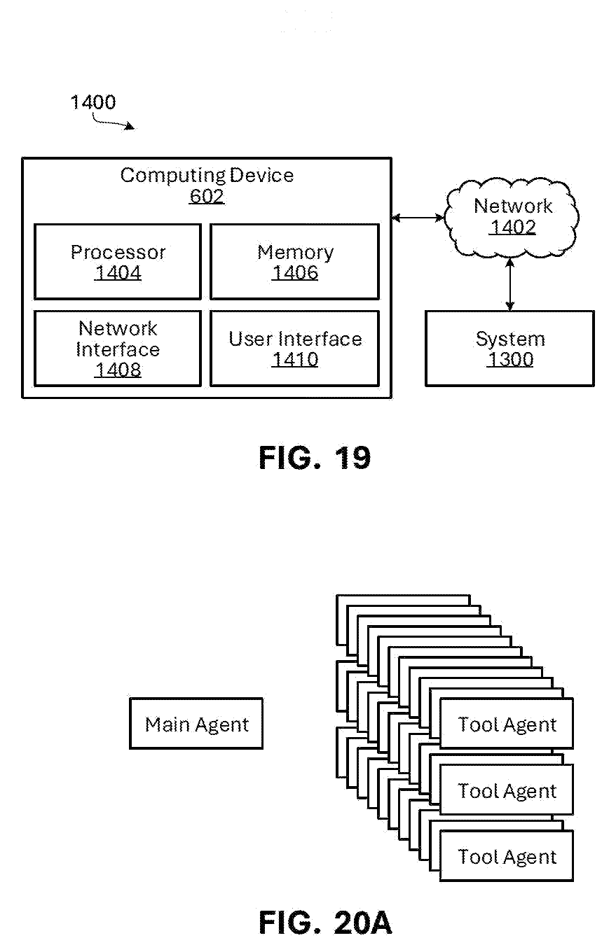

FIG. 19 depicts a computing system 1400, which allows computing device 602 (e.g. a user device) to communicate with system 1300 over a network 1402. It will be appreciated that system 1400 may include computing device 602, first AI agent 604 and first resource 606 depicted in system 600. In some further implementations of system 1400, computing device 602 may not need to communicate with system 1300 over a network, and computing device 602 may include first AI agent 604 and/or first resource 606.

It will be appreciated that in other implementations, system 1400 may allow computing device 602 to communicate with more than one system, such as a combination system 1300 and other systems. In these implementation, first resource 606 and/or other AI agents or resources used in the workflow may be stored in one or more other systems accessible by computing device 602, such as over network 1402.

Computing device 602 includes at least one processor 1404 and at least one physical memory 1406. Processor 1404 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. Memory 1406 may include a volatile or non-volatile memory (e.g., a flash memory, a random access memory (RAM), and/or a read-only memory (ROM)). The memory 1406 may store instructions for execution by the processor 1402.

Computing device 602 may also include at least one network interface 1408 for wired and/or wireless communications with an external system and/or network (e.g., an intranet, the Internet, a P2P network, a WAN and/or a LAN). A network interface may enable computing device 602 to carry out communications (e.g., wireless communications) with systems external to computing device 602, such as system 1300, over network 1402. The structure of the network interface 1408 will depend on how computing device 602 interfaces with the network. For example, if computing device 602 is a smartphone or tablet, the network interface 1408 may comprise a transmitter/receiver with an antenna to send and receive wireless transmissions over the network 1408. If the computing device 602 is a personal computer connected to the network 1402 with a network cable, the network interface 1408 may comprise a network interface card (NIC), and/or a computer port (e.g. a physical outlet to which a plug or cable connects), and/or a network socket, etc.

Computing device 602 may optionally include at least one input/output (I/O) interface 1410, alternatively referred to as user interface 1410, which may interface with optional input device(s) (not shown) and/or optional output device(s) (not shown). Input device(s) may include, for example, buttons, a microphone, a touchscreen, a keyboard, etc. Output device(s) may include, for example, a display, a speaker, etc. In this example, optional input device(s) and optional output device(s) may be external to computing device 602. In other examples, one or more of the input device(s) and/or output device(s) may be an internal component of computing device 602.

It will be appreciated that computing system 1400 may be used by a user computing device 602 to perform any of methods 700, 800, 900 and/or 1000. method 1000, Computing system 1700 may also be used by a user of computing device 602 to perform variations of these methods or other methods.

Computing system 1400 may receive user input, instructions or messages, which may be transmitted over network 1402 to system 1300 as messages (e.g., message 620). Computing system 1400 may receive information, including images, text and other data, from system 1300 via network 1402, such as in reply to input (e.g., reply 626 to message 620).

In some further implementations of system 1400, computing device 602 may first communicate over network 1402 or locally with a server, which may include a processor, a memory and a network interface. Computing device 602 may provide receive input via user interface 1410 or some other means and transmit that input (e.g., message 620) to the server, such as over network 1402. The server may transmit that input to system 1300. Computing device 602 may receive replies to input from the server, which may itself be transmitting replies from system 1300. Other configurations are also possible.

Technical benefits of some implementations described herein are as follows. A workflow including a first AI agent and a first resource is advantageously modified such that, responsive to a request from the first AI agent, an instruction is provided to the first AI agent in addition to a response from the first resource to the request.

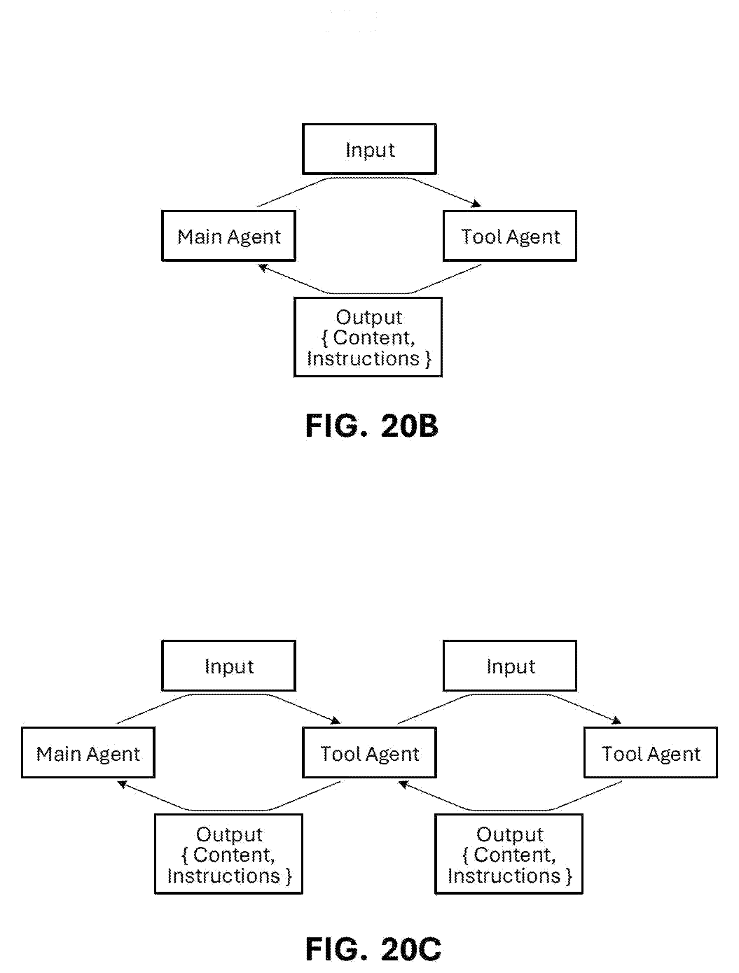

For example, FIG. 20A depicts an example of the difficulties inherent in workflows with AI agents and resources. Consider a main AI agent that has one hundred available resources to call for various specialized tasks. These resources may include AI agents and/or non-AI software modules. Resources which are AI agents may also be referred to as “tool agents” herein. If the system developers develop a further (one-hundredth-and-one) resource or tool with a new capability, the system or developers may be required to update the system and/or workflow with information about the additional resource or tool. It may be difficult to inform or configure the other AI agents or resources in the workflow about what to do with the output it may receive from the new resource or tool. Conversely, the methods and systems described herein may allow new AI agents and/or resources to be added to an existing system or workflow without needing to inform or reconfigure the other AI agents and/or resources in the workflow. Instead, an AI agent which sends a request to a resource may receive an instruction along with response from the resource to the request, such that any additional information the AI agent may have required from reconfiguration may now be included in the instruction. The same principle may also apply to resources, which may include AI agents and non-AI software tools, which may also receive instructions with responses to their requests.

In addition, in many situations an AI agent may not be equipped to handle certain responses received from resources to which it makes requests, even if the AI agent has been informed about the resource and/or reconfigured or retrained based on the resource. In particular, the AI agent may receive a prompt or message from a computing device (e.g. a user device). The AI agent may make a request to a resource to help it generate a reply to the prompt or message from the computing device. However, in these situations the AI agent may be more likely to produce errors while generating its own reply to the prompt, because it is not properly configured to handle the response from the resource. Even if the AI agent receives detailed instructions from the computing device in the prompt or message, the computing device may still be unable to provide the AI agent with detailed handling instructions for responses from the resource. For example, the computing device may not have any visibility of or knowledge about the resource. As a result, the AI agent may mishandle the response from the resource to the request, possibly producing errors in the reply to the prompt, which may be eventually transmitted to the computing device. For example, if the resource does not provide sufficient information in the response, the AI agent may be likely to include errors in its reply, which may include errors due to a lack of information and may include hallucination. Computing resources may be wasted by re-prompting the AI agent to generate a correct reply, or in detecting erroneous replies, or in repeated requests made by the AI agent due to mishandling of previous responses used in other stages of the workflow.

Other solutions which provide additional configurations to AI agents and resources about how to handle responses received from other resources may complicate the workflow and system architecture. These configurations may consume memory resources and processing power, as the AI resource must be configured to handle responses from any of the possible resources it may query with a request. Alternatively, the systems and methods described herein only require an instruction to be provided along with the response from the resource, such that requesting AI agents or resources do not need special expertise in handling responses from every resource.

Moreover, although it may be possible to prompt the AI agent with instructions about how to handle a response received from the resource, this approach may become intractable as the complexity of the architecture increases, such as where the AI agent is only a first AI agent and the resource is only one of many other AI agents and resources in the system or workflow. For example, the resource may also be an AI agent, e.g. a second AI agent, which may provide a request to a second resource. It may be difficult to propagate instructions for how the second AI agent is to handle the response from the second resource in the message from the computing device to the first AI agent. This would require the first AI agent to be provided with information about the second resource, which operates further down in the workflow hierarchy, complicating the system and consuming significant computational resources (e.g. memory) as the workflow grows more complex.

As well, solutions which involve training an AI agent on a particular resource may also become intractable as complexity increases. As the number of AI agents and/or resources increases, so do the computing resources necessary to either train the AI agents based on the different resources or to set up workflows to address edge cases.

In addition to these challenges, a workflow may also function less effectively when the AI agent is either unequipped to handle a response from the resource or when messages/prompts to the AI agent must be over-engineered to ensure responses from the resource are handled properly by the AI agent. As developers add further complexity to the system or workflow, significant testing must be performed to ensure that edge-cases and new workflows are considered. In addition to consuming significant computational resource just to test this system, the system may still not function as effectively as it should because entire workflows must be hardcoded into the top layers of the system (e.g. at the top-level message or prompt to the AI agent or to whichever agent instructs the workflow). Nuances of resources within the workflow may be inadvertently omitted, and the system’s performance may ultimately suffer.

One could also envision a system where all the resources output the same format or style of information. This may represent a major engineering limitation and could limit the capabilities that such a system could provide and/or employ. For example, the system could have more capabilities and thus be more useful if it employs a diverse set of resources or tools. This may also be true if the resources provide a wider set of capabilities and include different output and/or result formats to the different AI agents and other resources.

In conventional systems, AI agents may be configured to call resources and to handle and/or process the output of such resources by prompting, fine-tuning or training the AI agent with/according to such information (e.g., agent names, capabilities, result formats, etc.). In some cases, some or all this information could, additionally or alternatively, be provided to an LLM employed in such a model using dynamic prompting with an LLM included in or utilized by a given agent.

A distinction may be drawn between such dynamic prompting and the systems and methods described herein, at least because, rather than dynamically prompting an LLM included in an AI agent, in the methods and systems described herein, a hybrid output including both a response and an instruction may be provided as a result from a resource to the AI agent. The instruction may then constrain the output or operations of the AI agent, including how the AI agent handles the content of the response, as depicted in FIG. 20B.

Conveniently, another technical benefit of the systems and methods described herein may also include the ability to scale. For example, the system may scale with the addition of new resources, such as by allowing additional resources (e.g. AI agents and other software modules) with specialist abilities to operate within the system or workflow without needing to reprogram the topmost AI agent. This may allow a resource to transfer its specialist ability back to the AI agent or resource which sent it the request. Furthermore, and as depicted in FIG. 20C, this may allow the AI agent or resource receiving the response and instruction from the resource with specialist ability to further transmit that specialist knowledge back to the AI agent or resource which originally called it, and eventually back to the user who prompted the system in the first place.

The technical benefits of the systems and methods described herein may also result from constraining the operation of the requesting AI agent based on the identity, characteristics, feedback or response from the responding resource. An instruction may be provided to the AI agent as a system or user prompt or as some other mechanism constraining the output of the AI agent (and, in particular, the output of the LLM in the AI agent). In this way, the AI agent may be configured just-in-time to handle the response received from the resource, whether or not the AI agent was actually trained on how to handle responses from the resource. The constrained operation of the AI agent may include the generation of certain output, subsequent requests to the same or other resources (including other AI agents) and the handling of certain content in the response from the resource which received the AI agent’s request.

It will be appreciated that other benefits may also be apparent.

### Conclusion

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
transmitting, to a first resource, a request from a first artificial intelligence (AI) agent;
receiving, at the first AI agent, a response bundle responsive to the request from the first AI agent, the response bundle comprising a response from the first resource to the request and an instruction for the first AI agent; and
performing, by the first AI agent, an operation responsive to the instruction.

2. The computer-implemented method of claim 1, wherein the instruction instructs the first AI agent to handle the response from the first resource in a way specified by the instruction.

3. The computer-implemented method of claim 1 , wherein the instruction is at least one of an instruction for formatting the response, an instruction for error handling, an instruction to refer the request from the first AI agent to another resource, an instruction to provide more information to the first resource, an instruction for the first AI agent to obtain more information, an instruction for the first AI agent not to perform an operation, or task feedback for the first AI agent responsive to the request.

4. The computer-implemented method of claim 1, further comprising:
receiving, at the first AI agent, a message from a computing device, wherein the first AI agent transmits the request to the first resource responsive to receiving the message;
prompting the first AI agent with the response from the first resource and the instruction for the first AI agent to perform the operation;
generating, responsive to the prompt, a reply from the first AI agent to the message, wherein the reply comprises content from the response handled in a way specified by the instruction; and
transmitting, to the computing device, the reply from the first AI agent.

5. The computer-implemented method of claim 1, wherein the response bundle further comprises an example based on the instruction for the first AI agent.

6. The computer-implemented method of claim 1, wherein the first resource is a second AI agent.

7. The computer-implemented method of claim 1, further comprising:
transmitting, to a second resource, a request from the first resource, wherein the request from the first resource is based on the request from the first AI agent;
receiving, at the first resource, a second response bundle responsive to the request from the first resource, the second response bundle comprising a response from the second resource to the request from the first resource and an instruction for the first resource; and
generating at least one of the response from the first resource or the instruction for the first AI agent based on the second response bundle.

8. The computer-implemented method of claim 1, further comprising validating the response bundle before the first AI agent receives the response bundle.

9. The computer-implemented method of claim 1, further comprising determining the instruction for the first AI agent based on the response from the first resource.

10. The computer-implemented method of claim 1, wherein performing, by the first AI agent, an operation responsive to the instruction comprises:
parsing, by the first AI agent, the instruction from the response bundle; and
performing, based on the parsed instruction, the operation using content included in the response from the first resource.

11. The computer-implemented method of claim 1, wherein the response from the first resource is empty and the instruction is for error handling.

12. A system comprising:
a memory; and
at least one processor to:
transmit, to a first resource, a request from a first artificial intelligence (AI) agent;
receive, at the first AI agent, a response bundle responsive to the request from the first AI agent, the response bundle comprising a response from the first resource to the request and an instruction for the first AI agent; and
perform, by the first AI agent, an operation responsive to the instruction.

13. The system of claim 12, wherein the instruction instructs the first AI agent to handle the response from the first resource in a way specified by the instruction.

14. The system of claim 12, wherein the instruction is at least one of an instruction for formatting the response, an instruction for error handling, an instruction to refer the request from the first AI agent to another resource, an instruction to provide more information to the first resource, an instruction for the first AI agent to obtain more information, an instruction for the first AI agent not to perform an operation, or task feedback for the first AI agent responsive to the request.

15. The system of claim 12, wherein the at least one processor is to:
receive, at the first AI agent, a message from a computing device, wherein the first AI agent transmits the request to the first resource responsive to receiving the message;
prompt the first AI agent with the response from the first resource and the instruction for the first AI agent to perform the operation;
generate, responsive to the prompt, a reply from the first AI agent to the message, wherein the reply comprises content from the response handled in a way specified by the instruction; and
transmit, to the computing device, the reply from the first AI agent.

16. The system of claim 12, wherein the first resource is a second AI agent.

17. The system of claim 12, wherein the at least one processor is to:
transmit, to a second resource, a request from the first resource, wherein the request from the first resource is based on the request from the first AI agent;
receive, at the first resource, a second response bundle responsive to the request from the first resource, the second response bundle comprising a response from the second resource to the request from the first resource and an instruction for the first resource; and
generate at least one of the response from the first resource or the instruction for the first AI agent based on the second response bundle.

18. The system of claim 12, wherein performing, by the first AI agent, an operation responsive to the instruction comprises:
parsing, by the first AI agent, the instruction from the response bundle; and
performing, based on the parsed instruction, the operation using content included in the response from the first resource.

19. The system of claim 12, wherein the response from the first resource is empty and the instruction is for error handling.

20. One or more non-transitory computer readable media having stored thereon computer-executable instructions that, when executed by at least one computer, cause the at least one computer to perform a method comprising:
transmitting, to a first resource, a request from a first artificial intelligence (AI) agent;
receiving, at the first AI agent, a response bundle responsive to the request from the first AI agent, the response bundle comprising a response from the first resource to the request and an instruction for the first AI agent; and
performing, by the first AI agent, an operation responsive to the instruction.
